(19) United States
(12) Patent Application Publication
(10) Pub. No.: US 2023/0205857 A1
(43) Pub. Date: Jun. 29, 2023

(54) AUTHENTICATION TERMINAL AND SECURITY SYSTEM

(71) Applicants: Mitsubishi Electric Corporation, Tokyo (JP); AnchorZ Inc., Tokyo (JP)

(72) Inventors: Kimiaki SATO, Tokyo (JP); Hidematsu HAYASHI, Tokyo (JP); Takashi SAEKI, Tokyo (JP); Yuki KONO, Tokyo (JP); Masaaki TOKUYAMA, Tokyo (JP)

(73) Assignees: Mitsubishi Electric Corporation, Tokyo (JP); AnchorZ Inc., Tokyo (JP)

(21) Appl. No.: 18/014,113

(22) PCT Filed: Aug. 3, 2020
(86) PCT No.: PCT/JP2020/029715

§ 371 Date: Dec. 30, 2022

(51) Int. Cl. G06F 21/32; G06V 40/20

(52) U.S. Cl. CPC G06F 21/32; G06V 40/20

(57) ABSTRACT

An authentication terminal (2) includes a behavior information acquisition unit (232) that acquires a plurality of types of behavior information acquired on the basis of an action of a worker who is a subject of personal authentication, and an authentication unit (25) that performs identity authentication of the worker on the basis of a comprehensive evaluation obtained by comprehensively evaluating the plurality of types of the behavior information. The authentication terminal (2) performs the identity authentication of the worker on the basis of the comprehensive evaluation obtained by comprehensively evaluating the plurality of types of the behavior information, and thus can perform user-friendly personal authentication using the behavior information of an individual.

### FIELD

The present disclosure relates to an authentication terminal and a security system for performing personal authentication on the basis of behavior of a person.

### BACKGROUND

Conventional personal authentication for identifying an individual has used an authentication key registered in an identification (ID) card that identifies a user on the assumption that the individual in question possesses the ID card. Therefore, there has been a problem in that, in a case where the ID card is lent to another person or stolen, a third party is authenticated as the individual to whom the ID card belongs.

The personal authentication also performs biometric authentication using biometric information such as a fingerprint and an iris. However, the personal authentication based on the biometric authentication is a mechanism in which a third party such as a company to which an individual belongs holds the biometric information that can uniquely identify the individual, that is, personal information that can uniquely identify the individual. Therefore, the personal authentication based on the biometric authentication has had a possibility that the personal information leaks from the third party. In addition, with the increasing importance of protection of the personal information in recent years, the possession of the personal information by the company can increase the company’s risk.

Moreover, as for security situations in a factory, a crime has occurred in which a malicious third party illegally acquires personal information such as an email or an employee name, breaks into a system of the factory by abusing the acquired personal information, and locks a function of the factory using ransomware or the like. For this reason, the importance of security in factories is increasing.

Now, Patent Literature 1 discloses that, instead of the biometric information, information on a user-specific action pattern is used for the personal authentication. In a personal authentication device disclosed in Patent Literature 1, a user registers in advance his/her own action history information as past information in the personal authentication device, and inputs his/her latest action history information to the personal authentication device before actually using an object subjected to security management by the personal authentication device. Then, the personal authentication device having the above configuration compares and checks the input action history information against the past action history information already registered, determines whether or not the input action history information and the past action history information are of the same person from a result of the comparison and checking, and outputs a result of the determination to an external device.

### CITATION LIST

### Patent Literature

Patent Literature 1: Japanese Patent Application Laid-open No. 2004-310207

### SUMMARY

### Technical Problem

However, the technique described in Patent Literature 1 performs the personal authentication only by behavior information including information on a route through which the user passes, so that the accuracy of the personal authentication cannot be improved unless the accuracy of the behavior information is improved, and the personal authentication has poor usability for use in factory security, for example.

The present disclosure has been made in view of the above, and an object thereof is to provide an authentication terminal capable of performing user-friendly personal authentication using behavior information of an individual.

### Solution to Problem

In order to solve the above-described problems and achieve the object, an authentication terminal according to the present disclosure includes: a behavior information acquisition unit to acquire a plurality of types of behavior information acquired on the basis of an action of a worker who is a subject of personal authentication; and an authentication unit to perform identity authentication of the worker on the basis of a comprehensive evaluation obtained by comprehensively evaluating the plurality of types of the behavior information.

### Advantageous Effects of Invention

The authentication terminal according to the present disclosure produces an effect whereby it is possible to perform user-friendly personal authentication using the behavior information of an individual.

### BRIEF DESCRIPTION OF DRAWINGS

FIG. 1 is a block diagram schematically illustrating an example of a configuration of a security system according to a first embodiment.

FIG. 2 is a schematic diagram illustrating an example of the configuration of the security system according to the first embodiment.

FIG. 3 is a flowchart illustrating a procedure of operation of the security system according to the first embodiment.

FIG. 4 is a schematic diagram for explaining a method of registering a worker ID in a worker ID storage unit of a management terminal in the security system according to the first embodiment.

FIG. 5 is a flowchart illustrating a procedure of the method of registering the worker ID in the worker ID storage unit of the management terminal in the security system according to the first embodiment.

FIG. 6 is a table illustrating an example of a database provided in a storage unit of the management terminal in the security system according to the first embodiment.

FIG. 7 is a flowchart illustrating a procedure of behavior authentication performed by an authentication unit of an authentication terminal in the security system according to the first embodiment.

FIG. 8 is a flowchart illustrating a procedure of a method of authenticating the use of equipment 4 by a scheduled worker of the next day in the security system according to the first embodiment.

FIG. 9 is a conceptual diagram for explaining a case where an authentication technique in the security system according to the first embodiment is applied to authentication of an access right to a cloud service.

FIG. 10 is a conceptual diagram for explaining a case where the authentication technique in the security system according to the first embodiment is applied to authentication of an access right to a cloud service.

FIG. 11 is a conceptual diagram for explaining a case where the authentication technique in the security system according to the first embodiment is applied to a security system for entry/exit of a worker into/from a room with an entrance restriction.

FIG. 12 is a conceptual diagram for explaining a case where the authentication technique in the security system according to the first embodiment is applied to an inspection authority management system that manages an inspection authority of a worker.

FIG. 13 is a conceptual diagram for explaining a case where a security system according to a second embodiment is applied to a guest visiting a factory.

FIG. 14 is a flowchart illustrating a procedure of operation of the security system according to the second embodiment.

FIG. 15 is a table illustrating an example of a database provided in a storage unit of a management terminal in the security system according to the second embodiment.

FIG. 16 is a conceptual diagram for explaining a production system of a factory according to a third embodiment.

FIG. 17 is a conceptual diagram for explaining a site management system of a factory according to a fourth embodiment.

FIG. 18 is a flowchart illustrating a procedure of processing in the site management system of the factory according to the fourth embodiment.

FIG. 19 is a conceptual diagram for explaining a site management system of a factory according to a fifth embodiment.

FIG. 20 is a table illustrating a determination method on a management terminal according to the fifth embodiment.

FIG. 21 is a diagram illustrating a configuration of a machine learning device according to a sixth embodiment.

FIG. 22 is a diagram illustrating an example of a hardware configuration of processing circuitry in the first embodiment.

### DESCRIPTION OF EMBODIMENTS

Hereinafter, an authentication terminal and a security system according to embodiments will be described in detail with reference to the drawings.

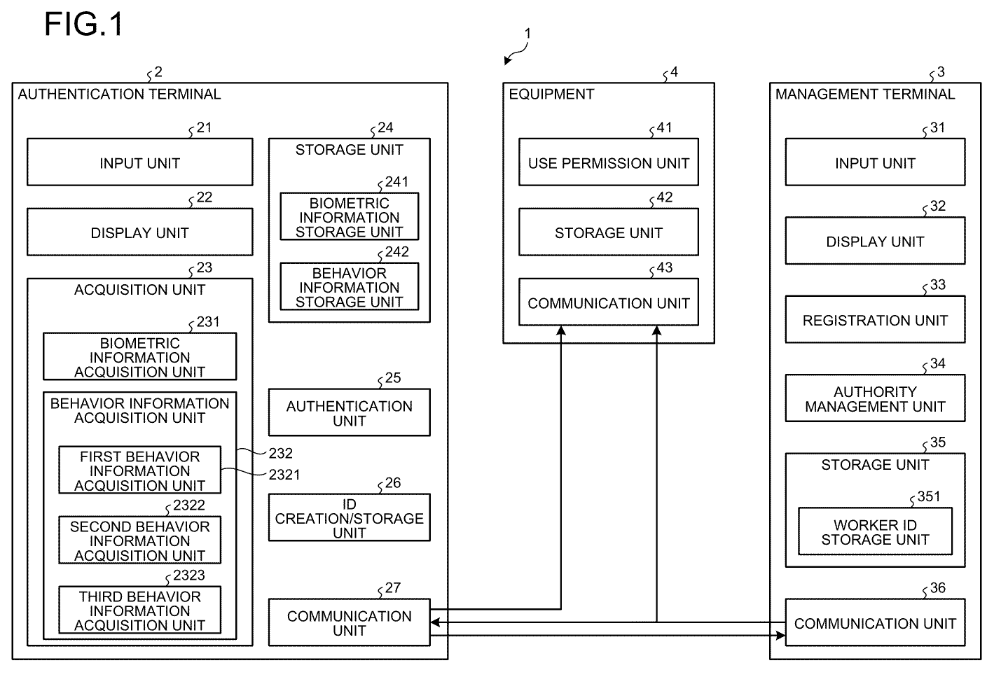

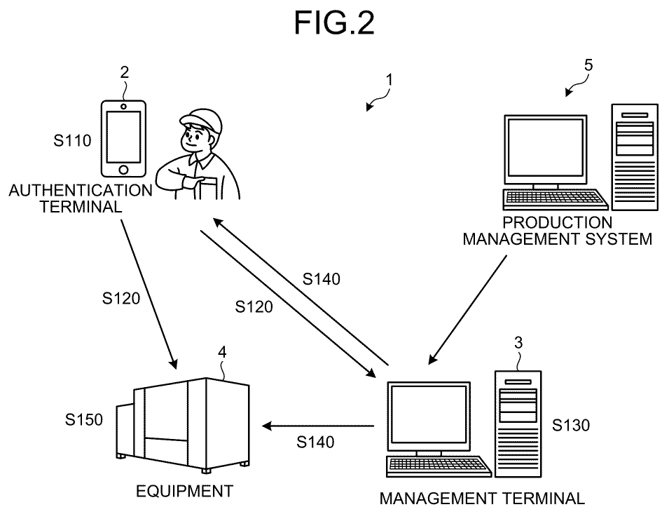

First Embodiment. (Authentication of authorized user of equipment at manufacturing site of factory) FIG. 1 is a block diagram schematically illustrating an example of a configuration of a security system according to a first embodiment. FIG. 2 is a schematic diagram illustrating an example of the configuration of the security system according to the first embodiment. First, an overview of a security system 1 according to the first embodiment will be described.

The security system 1 includes an authentication terminal 2 that is held by a worker, who works in a factory into which the security system 1 is introduced, and performs personal authentication, a management terminal 3 that manages equipment use authority as authority to use equipment 4 in the factory, and the equipment 4 installed in the factory. The authentication terminal 2, the management terminal 3, and the equipment 4 can communicate with one another.

The authentication terminal 2 is a personal authentication terminal that has a personal authentication function of performing personal authentication of the worker who is a user, and performs the personal authentication by behavior authentication based on behavior of the worker who holds the authentication terminal 2. The worker who is the user holding the authentication terminal 2 is a subject of personal authentication. When it is confirmed by the personal authentication that the worker is a worker having valid ownership of the authentication terminal 2, the authentication terminal 2 notifies the equipment 4 of a worker ID assigned to the worker having valid ownership of the authentication terminal 2. The worker ID is an ID unique to the worker, or identification information unique to the worker. As the authentication terminal 2, a communication device having the personal authentication function to be performed on the worker is used such as a smartphone having the personal authentication function to be performed on the worker or a communication card having the personal authentication function to be performed on the worker who is the subject of personal authentication.

The behavior information is information indicating behavior peculiar to the worker. The behavior information means information that identifies the worker on the basis of behavior of the worker such as commuting route information that is information on a commuting route from a worker’s home to the factory as a workplace, in-house travel route information that is information on a route that the worker arriving at the factory takes in the factory from a gate of the factory to the equipment 4 that the worker is in charge of or a personal computer (PC) on a desk of the worker, motion information that is information on a motion that occurs when the worker operates the equipment 4, used equipment information that is information for identifying the equipment 4 scheduled to be used by the worker, and area information that is information on an area where the worker is permitted to move. The motion information includes, for example, a motion in which the worker repeats movement from right to left, from left to right, from right to left, and from left to right at arbitrary intervals in order to operate the equipment 4. Note that the behavior information includes not only the behavior based on the motion of the worker but also information that is related to the behavior of the worker and leads to the identification of the worker such as the used equipment information.

The management terminal 3 manages the worker ID assigned to the worker. The management terminal 3 notifies the equipment 4 of the worker ID of the worker who is confirmed to be a worker having valid ownership of the authentication terminal 2 and to whom permission to use the equipment 4 is to be granted.

The equipment 4 refers to equipment related to production in the factory such as production equipment, a controller, and a monitoring device installed in the factory. The production equipment is equipment installed in the factory such as a processing machine, a mounting machine, or an assembling machine. The controller is a device that controls an operation of the production equipment installed in the factory from outside the production equipment. The monitoring device is a device that monitors a production status of the production equipment in the factory. The equipment 4 is controlled to be operable only when the worker ID identical to the worker ID received from the management terminal 3 is received from the authentication terminal 2.

That is, the security system 1 uses the worker ID output from the authentication terminal 2 only when the worker is authenticated to be valid by the behavior authentication on the authentication terminal 2, thereby allowing only the valid worker to operate the equipment 4 and preventing a malicious third party from operating the equipment 4.

Hereinafter, each configuration of the security system 1 will be described in detail. First, the authentication terminal 2 will be described.

The authentication terminal 2 includes an input unit 21, a display unit 22, an acquisition unit 23, a storage unit 24, an authentication unit 25, an ID creation/storage unit 26, and a communication unit 27.

The input unit 21 receives various types of information for the authentication terminal 2. As the input unit 21, for example, a known input device such as an operation button or a touch panel is used. The display unit 22 displays various types of information such as information input to the authentication terminal 2 and information related to personal authentication.

The acquisition unit 23 acquires and stores, at a predetermined period, information used for biometric authentication and personal authentication of the worker on the authentication terminal 2. The acquisition unit 23 includes a biometric information acquisition unit 231 that acquires biometric information, and a behavior information acquisition unit 232 that acquires behavior information.

The biometric information acquisition unit 231 acquires the biometric information of the worker and stores the acquired biometric information in a biometric information storage unit 241 to be described later. The biometric information means various types of physiological information given by a living body and includes, for example, information such as a face, a fingerprint, an iris, and a voice. The biometric information acquisition unit 231 acquires the biometric information using a device such as a biosensor including a fingerprint sensor, a camera, or a microphone installed on the authentication terminal 2. Note that the biometric information acquisition unit 231 may store the biometric information.

In addition, the biometric information acquisition unit 231 acquires feature information of the worker to register and store the feature information in the biometric information storage unit 241. The feature information is information that indicates a feature of the biometric information of the worker to be used as a criterion in the biometric authentication, and is checked, by the authentication unit 25, against the biometric information of the worker acquired by the biometric information acquisition unit 231. The biometric information acquisition unit 231 acquires the feature information using a device such as a biosensor including a fingerprint sensor, a camera, or a microphone installed on the authentication terminal 2. Note that the biometric information acquisition unit 231 may store the feature information.

The registration of the feature information will be described by taking, as an example, a case where information on a face of a person is used as the biometric information. In the case where the information on a face of a person is used as the biometric information, for example, the biometric information acquisition unit 231 digitizes information such as relative positional relationships among a plurality of parts on the face such as the eyes, the nose, and the mouth and the size of each part, thereby registering and storing the digitized information in the biometric information storage unit 241 as the feature information. In this case, the biometric information acquisition unit 231 controls the camera installed on the authentication terminal 2 to acquire an image of the face of the person. The person here is the worker who has valid ownership of the authentication terminal 2. The camera recognizes that the face of the person is included in a photographing range, and photographs the face of the person in the photographing range recognized. The biometric information acquisition unit 231 acquires the image of the face of the person photographed by the camera. The biometric information acquisition unit 231 uses the image of the face to digitize the information such as the relative positional relationships among the parts of the face such as the eyes, the nose, and the mouth and the size of each part, and stores the digitized information in the biometric information storage unit 241 as the feature information of the worker having valid ownership of the authentication terminal 2.

Furthermore, when performing the biometric authentication, the biometric information acquisition unit 231 acquires the biometric information of the worker who is the subject of personal authentication, that is, the worker who is subjected to the biometric authentication. In the case where the information on the face of the person is used as the biometric information, the biometric information acquisition unit 231 uses the camera to acquire an image of the face of the worker who is subjected to the biometric authentication. The biometric information acquisition unit 231 digitizes information such as relative positional relationships among parts on the face such as the eyes, the nose, and the mouth and the size of each part in the acquired image of the face, thereby registering and storing the digitized information in the biometric information storage unit 241 as the biometric information. Then, the authentication unit 25 performs the biometric authentication by comparing the feature information with the biometric information.

As described above, the biometric information of the worker who has valid ownership of the authentication terminal 2 is registered in advance as the feature information in the biometric information storage unit 241. The registration of the feature information is not limited to the above method, and can be performed by a known technique.

Note that a functional unit that acquires the above feature information and registers the feature information in the biometric information storage unit 241 may be provided as a feature information acquisition unit separately from the biometric information acquisition unit 231.

The behavior information acquisition unit 232 acquires the behavior information of the worker and stores the acquired behavior information in a behavior information storage unit 242 to be described later. The behavior information acquisition unit 232 acquires information related to behavior of the worker obtained by hardware implemented on the authentication terminal 2, an application implemented on the authentication terminal 2, and an operating system (OS) implemented on the authentication terminal 2. Note that the behavior information acquisition unit 232 may store the behavior information.

The behavior information acquisition unit 232 includes a first behavior information acquisition unit 2321, a second behavior information acquisition unit 2322, and a third behavior information acquisition unit 2323. The first behavior information acquisition unit 2321 acquires the behavior information including the information obtained from the hardware implemented on the authentication terminal 2. The second behavior information acquisition unit 2322 acquires the behavior information including the information obtained from the application implemented on the authentication terminal 2. The third behavior information acquisition unit 2323 acquires the behavior information including the information obtained from the OS implemented on the authentication terminal 2.

For example, the commuting route information as a first example of the behavior information acquired by the behavior information acquisition unit 232 is information obtained from the hardware such as a global positioning system (GPS) and an acceleration sensor implemented on the authentication terminal 2. The commuting route information is also information obtained from the application implemented on the authentication terminal 2 that processes information from the GPS and the acceleration sensor to trace a location of the worker. The behavior information acquisition unit 232 acquires the behavior information of the worker being the commuting route on the basis of the information acquired from the hardware implemented on the authentication terminal 2 and the application implemented on the authentication terminal 2.

Moreover, equipment information as a second example of the behavior information acquired by the behavior information acquisition unit 232 corresponds to information acquired from the communication unit 27 of the authentication terminal 2 that communicates with the equipment 4. The communication unit 27 is implemented by hardware and a communication application. The equipment information in this case is information obtained from the hardware or the communication application. The equipment information also corresponds to information such as an equipment name that is information on the equipment 4 input to the equipment 4 by a user in order for him to start operating the equipment 4, for example. The equipment information in this case is information obtained from an OS implemented on the equipment 4. That is, the behavior information acquisition unit 232 acquires the behavior information being the equipment information on the basis of the information acquired from the hardware implemented on the authentication terminal 2, the application implemented on the authentication terminal 2, and the OS implemented on the equipment 4.

Also, in this case, the equipment information serves as control information to be managed by a kernel included in the OS, for example. The kernel is software that can manage communication between hardware and software.

The equipment information may also be information such as the equipment name that is the information on the equipment 4 input to the authentication terminal 2 by a user in order for him to start operating the equipment 4. The equipment information in this case is information obtained from the OS implemented on the authentication terminal 2. That is, the behavior information acquisition unit 232 acquires the behavior information being the equipment information on the basis of the information acquired from the hardware implemented on the authentication terminal 2, the application implemented on the authentication terminal 2, and the OS implemented on the authentication terminal 2.

The behavior information acquisition unit 232 acquires various types of the behavior information and stores the acquired behavior information in the behavior information storage unit 242. The behavior information is as described above and, in the first embodiment, corresponds to the information such as the commuting route information, the in-house travel route information, and the used equipment information. The behavior information acquisition unit 232 can acquire the commuting route information using the GPS, the acceleration sensor, a distance to a wireless base station, Wireless Fidelity (Wi-Fi (registered trademark)), a magnetic sensor, or the like. The behavior information acquisition unit 232 can acquire a travel route in the factory from an entry/exit history at an entrance gate of the factory, the number of steps taken from the entrance gate, a distance to a nearby wireless base station, a route through which the authentication terminal 2 passes a wireless base station, information transmitted from a beacon set in the factory, or the like.

The behavior information acquisition unit 232 can acquire the used equipment information by a method such as a method of reading an equipment number from a bar code on the equipment 4 operated by the worker, a method of manually inputting the equipment number into the authentication terminal 2 by the worker, or a method of acquiring an image of the equipment number. The equipment number is an identification number that is assigned to each equipment 4 and unique to each equipment 4.

The acquisition of the behavior information by the behavior information acquisition unit 232 is started when, for example, the user inputs a behavior information acquisition start instruction, which is an instruction to start the acquisition of the behavior information, to the authentication terminal 2 using the input unit 21. Upon receiving the behavior information acquisition start instruction, the behavior information acquisition unit 232 starts the acquisition of the behavior information. Then, the acquisition of the behavior information ends when the user inputs a behavior information acquisition end instruction, which is an instruction to end the acquisition of the behavior information, to the authentication terminal 2 using the input unit 21. Upon receiving the behavior information acquisition end instruction, the behavior information acquisition unit 232 ends the acquisition of the behavior information.

Moreover, the behavior information acquisition unit 232 may acquire the behavior information constantly or in a predetermined acquisition time period so as to be able to acquire the behavior information even when the worker forgets to input the behavior information acquisition start instruction. Examples of the predetermined acquisition time period include a time period from when the user usually leaves home to when the user arrives at the factory, a time period from when the user leaves home to when the user arrives at his desk, and a time period from when the user leaves home to when the user arrives at a work site. The acquisition time period can be freely set and changed by the user.

The storage unit 24 includes a non-volatile memory, and stores various types of information of the authentication terminal 2. The storage unit 24 includes the biometric information storage unit 241 and the behavior information storage unit 242.

The biometric information storage unit 241 stores the biometric information of the worker used for biometric authentication. The biometric information storage unit 241 also stores the feature information that indicates a feature of the biometric information of the worker to be used as the criterion in the biometric authentication, and is checked, by the authentication unit 25, against the biometric information of the worker acquired by the biometric information acquisition unit 231. The feature information is stored in advance in the biometric information storage unit 241.

The behavior information storage unit 242 stores the behavior information used for personal authentication. The behavior information storage unit 242 also stores behavior teacher information. The behavior teacher information corresponds to behavior information about an individual specified in the biometric authentication previously performed, is behavior information used as a criterion for determination in the behavior authentication using the behavior information acquired from the behavior information storage unit 242 by the authentication unit 25, and is information to be compared with the behavior information acquired from the behavior information storage unit 242 by the authentication unit 25. The behavior teacher information is determined in advance for each type of the behavior information and stored in the behavior information storage unit 242.

The authentication unit 25 performs biometric authentication by comparing the biometric information of the worker, who is the subject of personal authentication, acquired by the biometric information acquisition unit 231 with the feature information. The authentication unit 25 performs personal authentication on the basis of the behavior information of the worker, who is the subject of personal authentication, acquired by the behavior information acquisition unit 232. Note that a functional unit that performs biometric authentication by comparing the biometric information of the worker, who is the subject of personal authentication, with the feature information may be provided as an individual biometric authentication unit.

The authentication unit 25 performs personal authentication by statistical processing using a plurality of types of the behavior information. The authentication unit 25 multiplies each of the plurality of types of the behavior information by a coefficient, and preferentially uses an important piece of the biometric information and an important piece of the behavior information for authentication. That is, the authentication unit 25 first identifies, on the basis of the biometric information, that the worker who is the subject of personal authentication is a worker with the feature information registered as the holder of the authentication terminal 2. Next, the authentication unit 25 performs personal authentication on the identified worker on the basis of the plurality of types of the behavior information. The authentication unit 25 can perform authentication exclusively on the identified worker by identifying the worker who is the subject of personal authentication on the basis of the plurality of pieces of the biometric information, thereby being able to improve authentication accuracy. In addition, the authentication unit 25 authenticates the worker who is the subject of personal authentication on the basis of the plurality of types of the behavior information, thereby being able to improve the authentication accuracy compared to a case of authenticating the worker who is the subject of personal authentication on the basis of one type of the behavior information.

Moreover, after authenticating the identity of the worker, the authentication unit 25 transmits, to the management terminal 3 via the communication unit 27, an authentication result that proves the identity of the worker, the worker ID that is the identification information unique to the worker associated with the worker, and the plurality of types of the behavior information used in personal authentication by the authentication unit 25. Therefore, the authentication unit 25 also functions as an authentication result output unit that transmits information related to the authentication result of the authentication terminal 2 to the management terminal 3. Note that the authentication result output unit may be provided separately from the authentication unit 25.

The ID creation/storage unit 26 creates and stores the worker ID that is the ID unique to the worker authenticated as an authorized worker by the authentication unit 25. The worker and the authentication terminal 2 held by the worker correspond to each other on a one-to-one basis. Therefore, the worker ID unique to the worker can be rephrased as an authentication terminal ID unique to the authentication terminal 2. Note that the worker ID may be stored in the storage unit 24.

That is, the ID creation/storage unit 26 creates and stores the worker ID for each authentication terminal 2 held by each worker. After the personal authentication of the worker by the authentication unit 25 is completed, the ID creation/storage unit 26 transmits the worker ID corresponding to the worker authenticated after the completion of the personal authentication to the communication unit 27, the worker ID being created and stored in advance for each worker. Note that after the personal authentication is completed by the authentication unit 25, the ID creation/storage unit 26 may create the worker ID corresponding to the worker authenticated after the completion of the personal authentication and transmit the created worker ID to the communication unit 27. As the worker ID, unique identification information such as a number created in advance is determined for each user. Not that, not limited to this, the ID creation/storage unit 26 may also create the worker ID using the behavior information of the worker who is authenticated after the completion of the personal authentication, thereby creating the worker ID indicating the identification information having the same content as in the above case.

The communication unit 27 wirelessly communicates with external devices including the management terminal 3 and the equipment 4 to transmit and receive information. Note that a communication method between the communication unit 27 and the external devices is not limited to wireless communication. The communication unit 27 transmits, to the management terminal 3, the authentication result of the personal authentication performed by the authentication unit 25, the plurality of types of the behavior information used in the personal authentication by the authentication unit 25, and the worker ID created by the ID creation/storage unit 26 for the worker authenticated in the personal authentication by the authentication unit 25. The communication unit 27 also transmits the authentication result of the personal authentication processing by the authentication unit 25 and the worker ID to the equipment 4.

Next, the management terminal 3 will be described. The management terminal 3 includes a device such as a personal computer, for example. The management terminal 3 has a function of managing association information in which the worker ID is associated with the worker, and enabling a function of the equipment 4 to be used by the worker after receiving the authentication result of the identity authentication on the authentication terminal 2 and the worker ID from the authentication terminal 2. Note that in a case where the management side, that is, the management terminal 3, also wishes to manage the behavior information as personal information, the authentication unit 25 transmits the authentication result, the worker ID, and the behavior information to the management terminal 3 after the authentication unit 25 performs the identity authentication of the worker. On the other hand, in a case where the management side, that is, the management terminal 3, does not wish to manage the behavior information as personal information, the authentication unit 25 does not transmit the behavior information to the management terminal 3 after the authentication unit 25 performs the identity authentication of the worker. The management terminal 3 includes an input unit 31, a display unit 32, a registration unit 33, an authority management unit 34, a storage unit 35, and a communication unit 36.

The input unit 31 receives various types of information for the management terminal 3. As the input unit 31, for example, various known input devices such as a keyboard, a mouse, or a touch panel are used. The display unit 32 displays various types of information such as information input to the management terminal 3 and information related to personal authentication.

The registration unit 33 registers a worker name, the worker ID, and use authority information, which is information on authority to use the equipment 4, of the worker who holds the authentication terminal 2 in the management terminal 3.

The authority management unit 34 determines and manages the worker permitted to use the equipment 4 for each equipment 4 using the worker ID. Specifically, the authority management unit 34 determines whether or not the authority to use the equipment 4 is to be given by using the worker ID. The authority management unit 34 determines whether the worker ID received from the authentication terminal 2 is managed in a worker ID storage unit 351 to be described later, that is, whether or not the received worker ID is stored in the worker ID storage unit 351.

In a case where the received worker ID is confirmed to be stored in the worker ID storage unit 351 described later, the authority management unit 34 determines that the worker corresponding to the received worker ID has the authority to use the equipment 4. The worker having the authority to use the equipment 4 is the worker who is permitted by the authority management unit 34 to operate the equipment 4. In this case, the authority management unit 34 transmits information on the received worker ID to the equipment 4 via the communication unit 36 as information indicating that the operation of the equipment 4 is permitted. That is, the worker ID information transmitted from the authority management unit 34 to the equipment 4 can be said to be operation permission information that is information indicating that the authority management unit 34 authenticates the worker corresponding to the worker ID received from the authentication terminal 2 as the worker who is permitted to operate the equipment 4 and permits the worker to operate the equipment 4.

In a case where the received worker ID is not confirmed to be stored in the worker ID storage unit 351, the authority management unit 34 determines that the worker corresponding to the received worker ID does not have the authority to use the equipment 4. The worker not having the authority to use the equipment 4 is a worker who is not permitted by the authority management unit 34 to operate the equipment 4. In this case, the authority management unit 34 transmits an error message indicating that the received worker ID is not stored in the worker ID storage unit 351 to the authentication terminal 2 via the communication unit 36.

The storage unit 35 includes a non-volatile memory, and stores various types of information of the management terminal 3. The storage unit 35 includes the worker ID storage unit 351 that stores and manages the worker ID for each worker. That is, the worker ID storage unit 351 manages the association information in which the worker ID is associated with the worker. On the management terminal 3, the worker ID storage unit 351 stores and manages equipment specifying information, which specifies the equipment 4 permitted to be used, in association with each worker ID.

The communication unit 36 wirelessly communicates with external devices including the authentication terminal 2 and the equipment 4 to transmit and receive information. Note that a communication method between the communication unit 36 and the external devices is not limited to wireless communication. The communication unit 36 transmits the worker ID of the worker permitted to use the equipment 4 to the equipment 4, and transmits the equipment specifying information specifying the equipment permitted to be operated to the authentication terminal 2. Moreover, the communication unit 36 receives, from the authentication terminal 2, the authentication result of the personal authentication from the authentication terminal 2, the plurality of types of the behavior information used in the personal authentication, and the worker ID created by the ID creation/storage unit 26 for the worker authenticated by the personal authentication.

Nest, the equipment 4 will be described. The equipment 4 has a function of comparing the worker ID transmitted from the management terminal 3, which is the worker ID of the worker permitted to use the equipment 4, with the worker ID acquired from the authentication terminal 2, and controlling the equipment 4 to be operable in a case where the two worker IDs match. That is, the management terminal 3 transmits and sets the worker ID of the worker, who is permitted to operate the equipment 4, to the target equipment 4 for each equipment 4. The equipment 4 compares the worker ID transmitted from the management terminal 3 and set in the equipment 4 with the worker ID transmitted and acquired from the authentication terminal 2, thereby determining whether or not to permit the operation of the equipment 4.

The equipment 4 includes a use permission unit 41, a storage unit 42, and a communication unit 43. Note that a functional unit for implementing a function unique to the equipment 4 is included in the equipment 4 but will not be described herein.

The use permission unit 41 compares the worker ID transmitted from the management terminal 3, which is the worker ID of the worker permitted to use the equipment 4, with the worker ID transmitted from the authentication terminal 2, and controls the equipment 4 to be operable in a case where the two worker IDs match. In addition, the use permission unit 41 sets, in the storage unit 42, the worker ID to which permission is given for each work hour period, and can perform control such that the use of the equipment 4 is permitted if the worker ID of the worker who can be permitted to use the equipment is received from the management terminal 3 in a time period that is within the set work hour period, or the use of the equipment 4 is not permitted if the time period is outside the set work hour period. That is, even when the worker ID acquired from the authentication terminal 2 matches the worker ID set in the storage unit 42, the use permission unit 41 does not permit the use of the equipment 4 if the time when the worker ID acquired from the authentication terminal 2 is received does not match the condition of the work hour period set to the worker ID registered in the storage unit 42. This can prevent a suspicious operation of the equipment 4 by the worker.

The storage unit 42 includes a non-volatile memory, and stores the worker ID acquired from the management terminal 3 and the worker ID acquired from the authentication terminal 2. The storage unit 42 also stores information related to the equipment 4 such as the equipment specifying information that specifies the equipment 4.

The communication unit 43 wirelessly communicates with external devices including the authentication terminal 2 and the management terminal 3 to transmit and receive information. Note that a communication method between the communication unit 43 and the external devices is not limited to wireless communication.

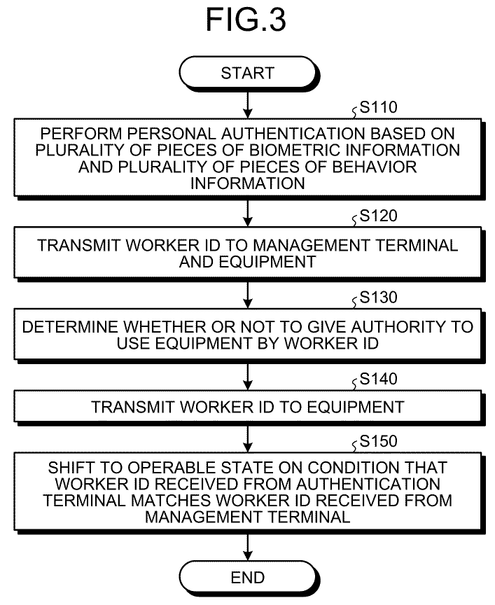

Next, an operation of the security system 1 will be described. First, an overview of the operation of the security system 1 will be described. FIG. 3 is a flowchart illustrating a procedure of the operation of the security system according to the first embodiment. Note that FIG. 2 illustrates steps corresponding to the description of FIG. 3.

In step S110, upon receiving an instruction to start personal authentication processing, the authentication unit 25 of the authentication terminal 2 performs the personal authentication using a plurality of pieces of biometric information of a worker and a plurality of types of behavior information of the worker acquired by the behavior information acquisition unit 232. The instruction to start the personal authentication processing is input to the authentication terminal 2 by the worker operating the input unit 21.

In step S120, the authentication unit 25 transmits a worker ID corresponding to the worker authenticated by the personal authentication in the authentication unit 25 to the management terminal 3 and the equipment 4. Note that, along with the worker ID, the authentication unit 25 transmits an authentication result of the personal authentication in the authentication unit 25 and the plurality of types of behavior information used for the personal authentication in the authentication unit 25 to the management terminal 3. The authentication unit 25 also transmits, along with the worker ID, the authentication result of the personal authentication by the authentication unit 25 to the equipment 4.

In step S130, the authority management unit 34 of the management terminal 3 determines whether or not to give authority to use the equipment 4 by using the worker ID. That is, upon receiving the worker ID, the authority management unit 34 checks whether the worker ID received is managed in the worker ID storage unit 351, that is, whether or not the worker ID received is stored in the worker ID storage unit 351.

In step S140, in a case where the worker ID received is confirmed to be stored in the worker ID storage unit 351, the authority management unit 34 determines that the worker corresponding to the worker ID received is a worker who is permitted to operate the equipment 4. Then, the authority management unit 34 transmits information on the worker ID received to the equipment 4 via the communication unit 36 as information indicating that the operation of the equipment 4 is permitted. That is, the worker ID information transmitted from the authority management unit 34 to the equipment 4 can be said to be operation permission information that is information indicating that the authority management unit 34 authenticates the worker corresponding to the worker ID received from the authentication terminal 2 as the worker who is permitted to operate the equipment 4 and permits the worker to operate the equipment 4.

On the other hand, in a case where the worker ID received from the authentication terminal 2 is not confirmed to be stored in the worker ID storage unit 351, the authority management unit 34 determines that the worker corresponding to the worker ID received is a worker who is not permitted to operate the equipment 4. In this case, the authority management unit 34 does not transmit the information indicating that the operation of the equipment 4 is permitted to the equipment 4. The authority management unit 34 transmits an error message indicating that the worker ID received is not stored in the worker ID storage unit 351 to the authentication terminal 2 via the communication unit 36.

Note that although the authority management unit 34 checks whether or not the authority to use the equipment 4 is given on the basis of the worker ID, the authority management unit may check whether or not the authority to use the equipment 4 is given on the basis of at least one of a name of the worker and an identification number for specifying the worker, in addition to the worker ID. The name of the worker and the identification number for specifying the worker acquired from the authentication terminal 2 are stored in the storage unit 24 of the authentication terminal 2.

In step S150, the equipment 4 shifts to an operable state on condition that the worker ID received from the authentication terminal 2 matches the worker ID received from the management terminal 3. That is, the use permission unit 41 of the equipment 4 controls the equipment 4 to be in an available state on condition that the worker ID received from the authentication terminal 2 matches the worker ID received from the management terminal 3.

By the above processing, in the security system 1, only a worker having valid authority to use the equipment 4 can operate the equipment 4. As a result, in the security system 1, only the valid worker can operate the equipment 4, and an operation of the equipment 4 by a malicious third party can be prevented.

In addition, there are a plurality of pieces of the equipment 4 in the factory. In a case where the authentication terminal 2 wishes to authenticate the authority to use a specific one of the equipment 4, the authentication unit 25 of the authentication terminal 2 acquires the equipment specifying information as the information for specifying the equipment 4, and transmits the acquired equipment specifying information to the management terminal 3 along with the worker ID. Equipment designating information for designating a specific one of the equipment 4 in the authentication of the authority to use the equipment 4 is input to the authentication terminal 2 along with the instruction to start the personal authentication by the worker operating the input unit 21.

On the management terminal 3, the worker ID storage unit 351 manages the equipment specifying information for permitting the use of the equipment 4 in association with each worker ID. After confirming that the worker ID is managed in the worker ID storage unit 351, the authority management unit 34 checks whether the worker ID managed in the worker ID storage unit 351 is associated with the same equipment specifying information as the equipment specifying information acquired. After confirming that the desired worker ID and the equipment specifying information are associated and managed in the worker ID storage unit 351, the authority management unit 34 transmits the worker ID information indicating that the use of the equipment 4 is permitted to the equipment 4 corresponding to the equipment specifying information via the communication unit 36.

In a case of specifying the equipment 4 for which authentication is to be performed, the worker inputs the equipment designating information of the equipment 4 for which authentication is desired to the authentication terminal 2. The authentication unit 25 of the authentication terminal 2 specifies the equipment 4 on the basis of the equipment designating information of the equipment 4 that has been input. Note that, not limited to this, the authentication terminal 2 may also communicate with the equipment 4 via wireless communication and acquire the equipment specifying information from the equipment 4, or the authentication terminal 2 may read a code attached to the equipment 4 and acquire the equipment specifying information from the equipment 4 on the basis of the code that has been read. A known technique can be used to read the code.

Moreover, the worker ID storage unit 351 of the management terminal 3 manages the equipment designating information of the equipment 4 permitted to be used for each worker ID, but may also manage a time period in which the use of the equipment 4 is permitted for each worker ID. That is, the worker in the factory operates the equipment 4 in a fixed work hour period based on an attendance time schedule. On the basis of the attendance time schedule, the worker ID storage unit 351 of the management terminal 3 sets the time period in which the use of the equipment 4 is permitted in the equipment specifying information. As a result, the authority management unit 34 refers to the worker ID storage unit 351 to be able to perform authentication for permission to use the equipment 4 only on the basis of the worker ID of the worker who has duly come to work for a work shift according to the attendance time schedule. Therefore, even if a third party impersonating the worker is authenticated by the authentication terminal 2, when the authentication is performed outside the work shift of the worker, the authority management unit 34 of the management terminal 3 does not permit the use of the equipment 4 so that security for the use of the equipment 4 can be further improved.

In this case, the authority management unit 34 has a clock function and compares the time when the worker ID is received from the management terminal 3 with information on the permitted time period set in the equipment specifying information managed in the worker ID storage unit 351. Only when the time when the worker ID is received from the management terminal 3 matches the permitted time period, the authority management unit 34 can confirm that the worker corresponding to the worker ID is the worker who has duly come to work for the work shift. The permitted time period is set in the equipment specifying information managed in the worker ID storage unit 351, and is a time period in which the operation of the equipment 4 is permitted based on the attendance time schedule of the worker. The permitted time period can be said to be time schedule information of the worker operating the equipment 4 based on the attendance time schedule. That is, the time schedule information is set in the equipment specifying information and stored in the worker ID storage unit 351 of the management terminal 3. Therefore, the authority management unit 34 gives the worker the authority to use the equipment 4 on the basis of the time schedule information.

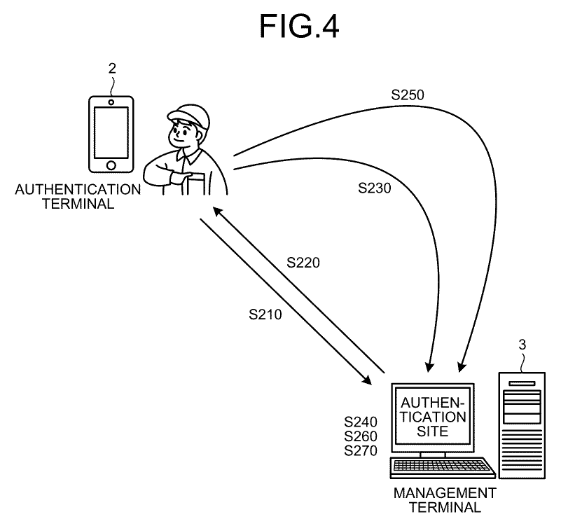

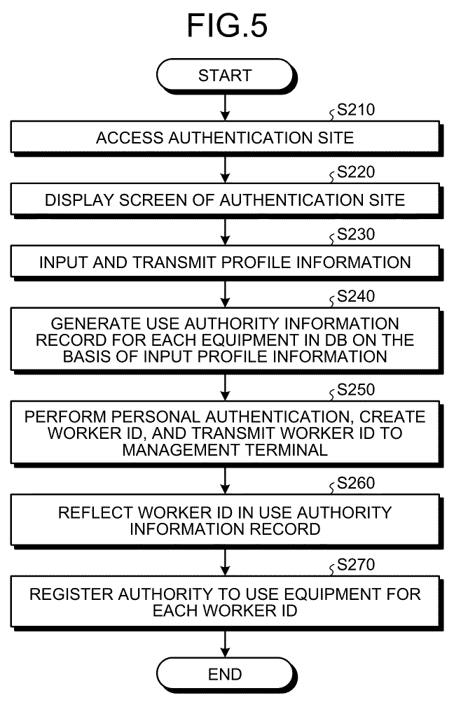

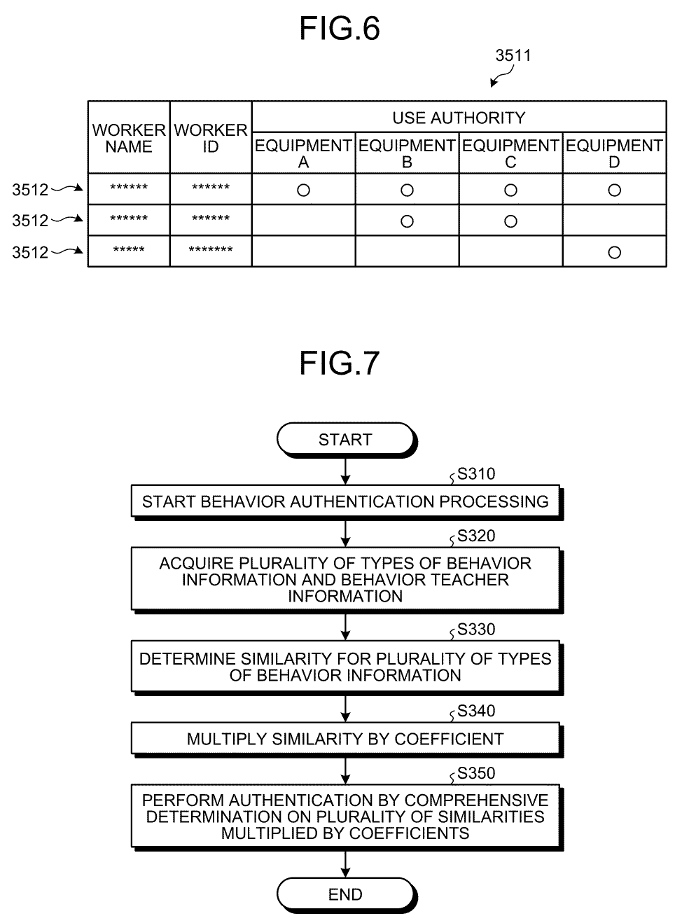

Next, a method of registering the worker ID in the worker ID storage unit 351 of the management terminal 3 will be described. FIG. 4 is a schematic diagram for explaining the method of registering the worker ID in the worker ID storage unit of the management terminal in the security system according to the first embodiment. FIG. 5 is a flowchart illustrating a procedure of the method of registering the worker ID in the worker ID storage unit of the security system according to the first embodiment. FIG. 6 is a table illustrating an example of a database provided in the storage unit of the management terminal in the security system according to the first embodiment.

In step S210, the authentication terminal 2 is connected to the registration unit 33 of the management terminal 3 through wireless communication according to an operation by the worker using the authentication terminal 2, and accesses an authentication site from the registration unit 33 of the management terminal 3.

In step S220, the authentication site that has accepted the access by the authentication terminal 2 allows the display unit 22 to display a screen of the authentication site. The authentication site is a website dedicated to the security system 1 for registering the worker ID in the worker ID storage unit 351 of the management terminal 3.

In step S230, the authentication terminal 2 transmits profile information of the worker who uses the authentication terminal 2 to the authentication site. Specifically, through an operation by a factory worker who uses the authentication terminal 2, the profile information of the factory worker using the authentication terminal 2 is newly input to the screen of the authentication site displayed on the display unit 22, and is transmitted to the authentication site. Examples of the profile information of the factory worker include information such as an employee number, a worker name, and a department to which he belongs.

In step S240, the registration unit 33 of the management terminal 3 generates a use authority information record 3512 in a database (DB) 3511 within the worker ID storage unit 351 of the storage unit 35 on the basis of the profile information transmitted to the authentication site. The database 3511 illustrated in FIG. 6 is a database for worker ID management in which the worker ID is stored in association with the worker name corresponding to the worker ID and use authority information that is information on the use authority for each equipment 4. As illustrated in FIG. 6, the use authority information record 3512 is a storage area in which the worker ID, the worker name corresponding to the worker ID, and the use authority information that is the information on the use authority for each equipment 4 are stored in association with one another. When the use authority information record 3512 is generated, the use authority information of the equipment 4 is not set.

In step S250, the authentication terminal 2 performs personal authentication of the worker using the authentication terminal 2, creates a worker ID, and transmits the created worker ID to the registration unit 33 of the management terminal 3. Specifically, the factory worker using the authentication terminal 2 performs a series of operations for performing the personal authentication on the authentication terminal 2, acquiring the worker ID upon authentication by the authentication terminal 2, and transmitting the worker ID from the authentication terminal 2 to the registration unit 33 of the management terminal 3.

In step S260, the registration unit 33 of the management terminal 3 receives the worker ID to register and reflect the received worker ID in the use authority information record 3512 generated in the DB.

In step S270, the registration unit 33 registers and saves, in the use authority information record 3512, the use authority information that is the information on the authority to use each equipment 4 for each worker ID, whereby the use authority information is reflected in the use authority information record 3512. Specifically, an administrator who manages the equipment use authority of the worker causes the information registered in the use authority information record 3512 to be displayed on the display unit 32 of the management terminal 3. Then, the administrator who manages the equipment use authority performs, for each worker ID, an operation of registration and saving in the use authority information record 3512 for each equipment 4 via the registration unit 33. A mark “o” in FIG. 6 indicates that the use authority information exists.

Next, behavior authentication performed by the authentication unit 25 of the authentication terminal 2 will be specifically described. FIG. 7 is a flowchart illustrating a procedure of behavior authentication performed by the authentication unit of the authentication terminal in the security system according to the first embodiment.

In step S310, the authentication unit 25 of the authentication terminal 2 starts processing of the behavior authentication at a predetermined processing start timing at which the behavior authentication is performed. The predetermined processing start timing is a timing at which the authentication unit 25 receives a personal authentication instruction, which is input to the authentication terminal 2 by an operation of the worker and indicates execution of personal authentication, and the authentication unit 25 completes biometric authentication on the worker.

The predetermined processing start timing may also be a timing at a predetermined time interval or a timing at which the acquisition unit 23 acquires new behavior information. The predetermined time interval is, for example, an interval of 10 minutes. However, in this case, the authentication unit 25 performs the biometric authentication on the worker before performing the behavior authentication and identifies that the worker holding the authentication terminal 2 is a worker with feature information being registered as the holder of the authentication terminal 2. In a case where the biometric authentication has failed, the authentication unit 25 does not proceed to the personal authentication based on the behavior authentication. The authentication unit 25 may also perform the behavior authentication using not only one processing start timing but also a plurality of types of processing start timings.

In step S320, the authentication unit 25 acquires a plurality of types of the behavior information of the worker holding the authentication terminal 2 from the behavior information storage unit 242. The authentication unit 25 also acquires the behavior teacher information from the behavior information storage unit 242 for each type of the behavior information acquired.

In step S330, the authentication unit 25 determines similarity for the plurality of types of the behavior information acquired. Specifically, the authentication unit 25 uses, for example, a statistical analysis method such as the Mahalanobis-Taguchi method (MT method) to determine the similarity between one type of the behavior information acquired and the behavior teacher information by distance. Likewise, the authentication unit 25 determines the similarity between the behavior information and the behavior teacher information by distance for other types of the behavior information among the plurality of types of the behavior information acquired. Hereinafter, the similarity between the behavior information and the behavior teacher information may be simply referred to as similarity.

In step S340, the authentication unit 25 multiplies the similarity determined for each of the plurality of types of the behavior information by a coefficient corresponding to importance for each type of the behavior information. Information on the importance for each type of the behavior information and the coefficient corresponding thereto are determined in advance for each type of the behavior information and stored in the authentication unit 25. Note that the information on the importance for each type of the behavior information and the coefficient corresponding thereto may be stored in the storage unit 24 of the authentication terminal 2.

Note that the importance for each type of the behavior information is determined by the accuracy of the behavior information and the dependence of the behavior information on the worker, and is stored in the authentication unit 25 in advance. For example, it is assumed that a route of passage of the worker in the factory is used as the behavior information. In some cases, the authentication terminal 2 cannot receive GPS information on the route of passage of the worker in the factory so that the accuracy of identifying the route of passage of the worker in the factory, which is the behavior information acquired by the behavior information acquisition unit 232, is poor and that the accuracy of the behavior information cannot be ensured to be higher than or equal to a predetermined standard. In the case where the accuracy of the behavior information cannot be ensured to be higher than or equal to the predetermined standard, the importance for each type of the behavior information is set low.

In other cases, on the route of passage of the worker in the factory, communication between a communication base station installed in the factory and the authentication terminal 2 has good communication accuracy so that the accuracy of identifying the route of passage of the worker in the factory is good and that the accuracy of the behavior information can be ensured to be higher than or equal to a predetermined standard. In the case where the accuracy of the behavior information can be ensured to be higher than or equal to the predetermined standard, the importance for each type of the behavior information is set high.

Moreover, in a case where the equipment 4 to be operated is determined by the worker such as in the case of the equipment 4 operated by the worker on the basis of a production plan, the importance for each type of the behavior information is set high since the dependence of the equipment 4 operated by the worker on the worker is high, that is, the dependence of the behavior information on the worker is high. Note that the importance may be changed by a user through parameter setting, or may be automatically set according to reliability of data of the behavior information acquired in the past.

In step S350, on the basis of a comprehensive determination using the similarities for the plurality of types of the behavior information multiplied by the coefficients, the authentication unit 25 determines that the worker identified by the biometric authentication is the worker himself/herself and authenticates that the worker identified by the biometric authentication is the worker having valid ownership of the authentication terminal 2. For example, in a case where a sum of the similarities for the plurality of types of the behavior information multiplied by the coefficients exceeds a predetermined reference value in the comprehensive determination, the authentication unit 25 authenticates that the worker identified by the biometric authentication is the worker having valid ownership of the authentication terminal 2.

Next, a description will be made of a method of authenticating the use of the equipment 4 by the worker during the execution of manufacturing work using the equipment 4 in the factory. As illustrated in FIG. 2, the security system 1 can be connected to a production management system 5 that manages a production plan of a product in the factory, the equipment 4, and the attendance time schedule of workers at night or the like. The production management system 5 for example transmits, as information related to the equipment 4 operating in the factory, scheduled worker information for the next day to the authority management unit 34 of the management terminal 3 and the equipment 4. The scheduled worker information for the next day is information on a scheduled worker of the next day for each equipment 4 and for each time period. That is, the scheduled worker information for the next day includes information on the equipment 4, information on the worker who uses the equipment 4, and information on the time period in which the equipment 4 is used for the work of the next day.

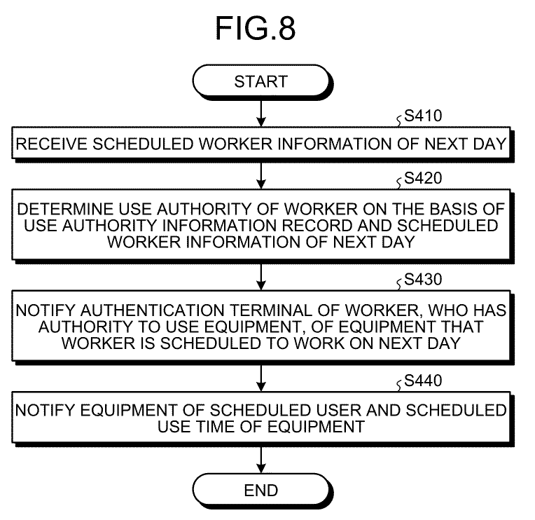

Hereinafter, a description will be made of processing by the management terminal 3 when the management terminal 3 receives the scheduled worker information for the next day. FIG. 8 is a flowchart illustrating a procedure of the method of authenticating the use of the equipment 4 by the scheduled worker of the next day in the security system according to the first embodiment.

In step S410, the authority management unit 34 of the management terminal 3 receives the scheduled worker information of the next day at the time of execution of manufacturing work of the day.

In step S420, the authority management unit 34 determines the use authority of the worker for the equipment 4 indicated in the scheduled worker information of the next day on the basis of the scheduled worker information of the next day and the use authority information record 3512 stored in the database 3511. That is, on the basis of the scheduled worker information of the next day and the use authority information record 3512 stored in the database 3511, the authority management unit 34 determines whether or not the worker indicated in the scheduled worker information of the next day is a worker having the use authority to operate the equipment 4 indicated in the scheduled worker information of the next day.

In step S430, the authority management unit 34 notifies the authentication terminal 2 of the worker, who is indicated in the scheduled worker information of the next day and has the use authority to operate the equipment 4 indicated in the scheduled worker information of the next day, of the equipment 4 that the worker is scheduled to work on the next day. The authority management unit 34 for example provides notification of a message of a “work schedule of the next day” such as “You are scheduled to use equipment □□ from oo o′clock to ΔΔ o′clock”.

In step S440, the authority management unit 34 notifies individual pieces of the equipment 4 indicated in the scheduled worker information of the next day of a scheduled user and a scheduled use time of the equipment 4. The authority management unit 34 for example provides notification of a message such as “The person who can use this equipment from oo o′clock to ΔΔ o′clock is a worker with an ID of ••”.

Note that in a case where the authority management unit 34 determines, on the basis of the scheduled worker information of the next day and the use authority information record 3512 stored in the database 3511, that the worker indicated in the scheduled worker information of the next day is not the worker having the use authority to operate the equipment 4 indicated in the scheduled worker information of the next day, the authority management unit 34 transmits a notification to that effect to the production management system 5. As a result, the production management system 5 can correct a mistake in the arrangement of the worker for the equipment 4 and rearrange the correct worker for the equipment 4 on the day before the work.

The worker can check the equipment 4 on which he is scheduled to work the next day on the authentication terminal 2 by the message of the “work schedule of the next day” sent from the management terminal 3 to the authentication terminal 2. At the start of actual work, the worker performs personal authentication on the authentication terminal 2 for the equipment 4 notified in the “work schedule of the next day”, and notifies the equipment 4 of the worker ID.

The equipment 4 compares the worker ID sent from the authentication terminal 2 of the worker with the worker ID information of the scheduled user of the equipment 4 sent from the management terminal 3 the day before, and transitions to an operable state if the worker ID matches the worker ID information.

The security system 1 performs the above processing for the scheduled use of the equipment 4 to be able to guarantee that only the worker having valid use authority can perform the work using the equipment 4, and to prevent a person who does not have valid use authority from impersonating the worker having valid use authority. Moreover, the security system 1 performs the above processing for the scheduled use of the equipment 4, so that a third party to whom an ID card such as a normal employee ID card has been lent or a third party who has stolen an ID card such as a normal employee ID card is not authenticated as the authentic person.

That is, in the security system 1, the authentication terminal 2 performs the personal authentication on the authentication terminal 2 using the plurality of types of the behavior information, whereby the accuracy of the personal authentication on the authentication terminal 2 can be improved. Moreover, the security system 1 uses the worker ID output from the authentication terminal 2 only when the worker is authenticated to be valid by the behavior authentication on the authentication terminal 2, so that only the valid worker can operate the equipment 4, and the operation of the equipment 4 by a malicious third party can be prevented.

Also, the security system 1 can improve the accuracy of the personal authentication on the authentication terminal 2 by using the natural behavior information of the worker, and thus the security system that is user-friendly and performs the personal authentication with high accuracy can be achieved even in a factory having a place where it is difficult to acquire the behavior information.

### First Application Example

The authentication technique in the security system 1 described above can be applied not only to the case where the use permission based on the result of personal authentication on the authentication terminal 2 is to be given for the equipment 4 in the factory but also to a case where such use permission is to be given for a work PC in the factory or a terminal for system management that manages a production system related to a production activity in the factory. The authentication technique in the security system 1 can further be applied to a case where the use permission based on the result of personal authentication on the authentication terminal 2 is to be given for a switch in a cloud system that controls the equipment 4 in the factory from a cloud server, a work entry terminal that registers details of work by the equipment 4 in the factory, and the like.

That is, the authentication technique in the security system 1 can prevent a person who does not have valid use authority from impersonating a person having the valid use authority as described above as long as the use permission based on the result of personal authentication on the authentication terminal 2 is to be given for the equipment 4 or equipment that requires identification of an authorized worker and an authorized operator.

### Second Application Example

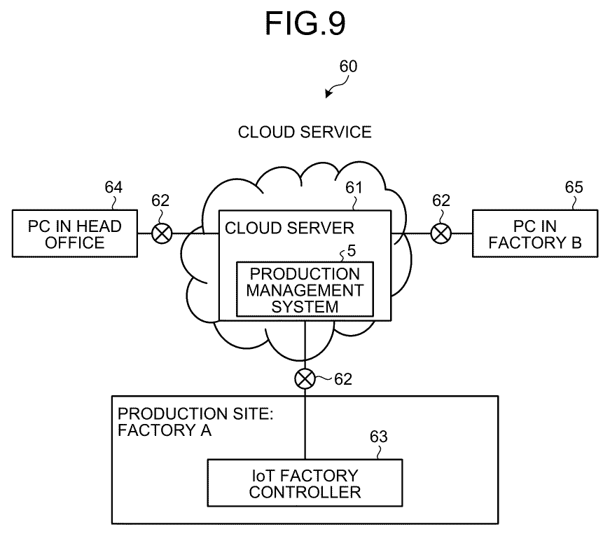

FIG. 9 is a conceptual diagram for explaining a case where the authentication technique in the security system according to the first embodiment is applied to authentication of an access right to a cloud service. As illustrated in FIG. 9, a security system 60 is assumed in which the production management system 5 that manages production activities in a factory is implemented by a cloud service. It is assumed that the production management system 5 that manages production activities in a factory A as a production site is implemented by using a cloud server 61 in the cloud service. In the factory A, an Internet of Things (IoT) factory controller 63 is disposed to be able to collect data of the production activities in the factory A and supply the data to the production management system 5 by connecting to the production management system 5 via Internet 62. The IoT factory controller 63 has, for example, a function of connecting to the cloud server 61 and a function of collecting data from the equipment 4 in the factory A.

The production management system 5 on the cloud server 61 can also be accessed from a PC 64 in a head office and a PC 65 in a factory B via the Internet 62. As a result, the PC 64 in the head office and the PC 65 in the factory B can use the production management system 5 and can use, for example, functions of a database and an application used in the production management system 5.

In this case, with the application of the authentication technique in the security system 1, the use permission based on the result of personal authentication on the authentication terminal 2 can be given for the access rights to the database and the application in the production management system 5. That is, an access to the database and the application in the production management system 5 by the worker from the authentication terminal 2 is permitted on the basis of the result of personal authentication on the authentication terminal 2.

In the present application example, a functional unit corresponding to the authority management unit 34 of the management terminal 3 and a functional unit corresponding to the use permission unit 41 of the equipment 4 described above are implemented on the cloud server 61. These functional units provided on the cloud server 61 acquire a worker ID transmitted from the authentication terminal 2, perform processing corresponding to the authority management unit 34 of the management terminal 3 and processing corresponding to the use permission unit 41 of the equipment 4, and permit the worker to access the database and the application in the production management system 5 from the authentication terminal 2. This can prevent a person who does not have a valid access right to the production management system 5 from impersonating a person having valid use authority to the production management system 5 and accessing the production management system 5. This as a result can prevent the cloud server 61 from being infected with malware such as ransomware, and can prevent damage caused to the production management system 5 by the malware.

Note that here, for easy understanding, the ID of an employee in the head office is described as the worker ID. Moreover, one functional unit that executes the function corresponding to the authority management unit 34 of the management terminal 3 and the function corresponding to the use permission unit 41 of the equipment 4 may be implemented on the cloud server 61.

### Third Application Example

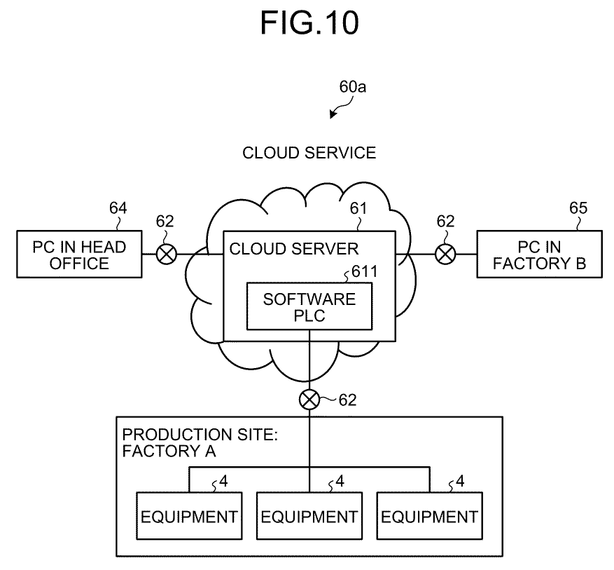

FIG. 10 is a conceptual diagram for explaining a case where the authentication technique in the security system according to the first embodiment is applied to authentication of an access right to a cloud service. The third application example will describe a modification of the second application example described above. In a security system 60a according to the third application example, the cloud server 61 implements a software programmable logic controller (PLC) 611 having a function of a drive controller that controls the operation of the equipment 4 in the factory A. That is, a production system according to the third application example is a production system that controls the operation of the equipment 4 in the factory A from the cloud server 61. Then, by applying the authentication technique in the security system 1, the production system according to the third application example can set and restrict the worker who can control the operation of the equipment 4 via the cloud service.

In the present application example, a functional unit corresponding to the authority management unit 34 of the management terminal 3 and a functional unit corresponding to the use permission unit 41 of the equipment 4 described above are implemented on the cloud server 61. These functional units provided on the cloud server 61 acquire a worker ID transmitted from the authentication terminal 2, perform processing corresponding to the authority management unit 34 of the management terminal 3 and processing corresponding to the use permission unit 41 of the equipment 4, and permit the worker to access the software PLC 611 from the authentication terminal 2. This can prevent a person who does not have a valid access right to the software PLC 611 from impersonating a person having valid authority to use the software PLC 611 and accessing the software PLC 611. This as a result can prevent the cloud server 61 from being infected with malware such as ransomware, and can prevent damage caused to the production management system 5 by the malware.

### Fourth Application Example

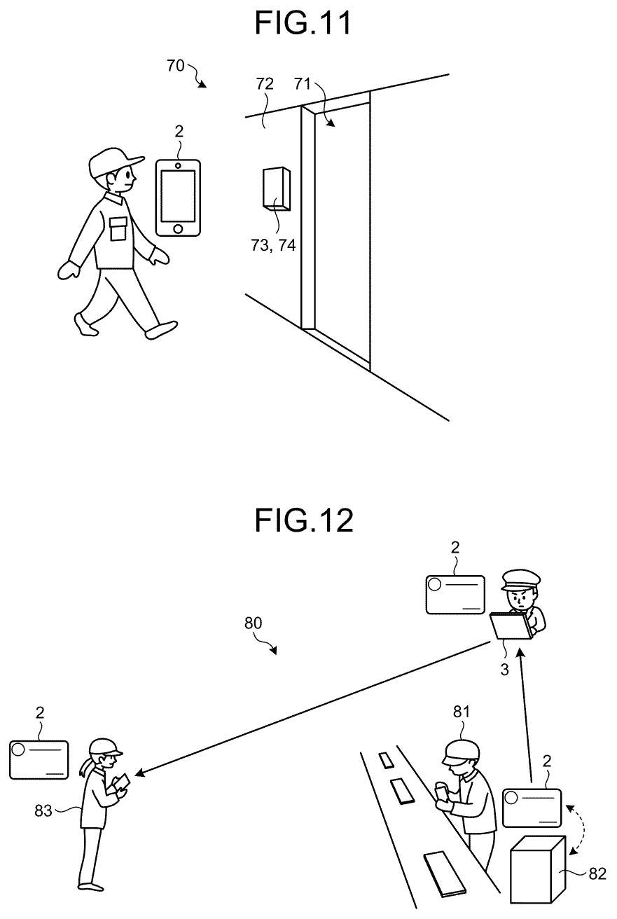

FIG. 11 is a conceptual diagram for explaining a case where the authentication technique in the security system according to the first embodiment is applied to a security system for entry/exit of a worker into/from a room with an entrance restriction. A security system 70 according to the fourth application example uses the authentication technique of the security system 1 described above, and the permission based on the result of personal authentication on the authentication terminal 2 is to be given for a right to enter an entry restricted room that is the room with the entrance restriction. In FIG. 11, the entry restricted room corresponds to a back side of the drawing with respect to a gate 71.

Specifically, outside the entry restricted room, a reader terminal 73 is disposed on a wall 72 near the gate 71 through which a person enters and exits the entry restricted room. Moreover, a communication device 74 capable of wirelessly communicating with the authentication terminal 2 is installed at a position near the gate 71 and within a range in which wireless communication can be established with the authentication terminal 2. When communication with the authentication terminal 2 is established by Wi-Fi or the like, the communication device 74 transmits authentication start information for instructing the authentication terminal 2 to start behavior authentication to the authentication unit 25 of the authentication terminal 2. Upon receiving the authentication start information, the authentication unit 25 of the authentication terminal 2 starts the behavior authentication. Note that the reader terminal 73 and the communication device 74 may be configured as individual devices or may be configured as one device. FIG. 11 illustrates a case where the reader terminal 73 and the communication device 74 are configured as one device.

The authentication unit 25 of the authentication terminal 2 creates a worker ID only when the worker holding the authentication terminal 2 is authenticated as a worker having valid ownership of the authentication terminal 2 by the behavior authentication, and transmits an authentication result as the worker ID to the reader terminal 73 and an opening/closing controller (not illustrated) that controls opening and closing of the gate 71. The reader terminal 73 performs entry/exit management and the like on the basis of the worker ID transmitted from the authentication terminal 2. For example, the reader terminal 73 includes a functional unit corresponding to the authority management unit 34 of the management terminal 3 and a functional unit corresponding to the use permission unit 41 of the equipment 4 described above, and manages entry/exit of the worker into/from the entry restricted room on the basis of the worker ID transmitted from the authentication terminal 2.

In this case, the reader terminal 73 stores room entry authority association information in which the worker ID is associated with room entry authority information that is information on authority to enter the entry restricted room. If determining that the worker ID transmitted from the authentication terminal 2 is registered in the room entry authority association information, the reader terminal 73 transmits the worker ID transmitted from the authentication terminal 2 to the opening/closing controller. The opening/closing controller opens the gate 71 on condition that the worker ID received from the authentication terminal 2 matches the worker ID received from the reader terminal 73. Note that the opening/closing controller may perform control to open the gate 71 to the worker who is authenticated as the worker having valid ownership of the authentication terminal 2.

Note that a typical entry/exit management system using an IC card encrypts communication such that an ID in the IC card is not stolen, and thus requires time for authentication.

On the other hand, the security system 70 according to the present application example places importance on the personal authentication properly completed by the behavior authentication and low importance on the ID itself, so that the communication does not need to be encrypted and the time required for authentication is shortened.

### Fifth Application Example

FIG. 12 is a conceptual diagram for explaining a case where the authentication technique in the security system according to the first embodiment is applied to an inspection authority management system that manages an inspection authority of a worker. As illustrated in FIG. 12, in an inspection authority management system 80 as a security system according to the fifth application example, regarding work of a certain worker 81, a third party can easily check whether or not the worker 81 has the work authority. For example, in an inspection process, when the worker 81 having only the inspection authority for a product A is inspecting a product B, the management terminal 3 can determine whether or not the worker 81 has the authority to inspect the product B using the worker ID of the worker 81, and can immediately know that the worker 81 is inspecting the product B without having the authority to inspect the product B.

That is, the authentication terminal 2 performs the authentication on the basis of the behavior information corresponding to the characteristics of the worker, thereby being able to identify, by the behavior authentication, the worker who performs the inspection without having valid inspection authority.

Specifically, when communication with the authentication terminal 2 is established by Wi-Fi or the like, a worker entry confirmation device 82 in which the worker performing the inspection work is registered transmits authentication start information for instructing the authentication terminal 2 to start the behavior authentication to the authentication unit 25 of the authentication terminal 2. Upon receiving the authentication start information, the authentication unit 25 of the authentication terminal 2 starts the behavior authentication.

The authentication unit 25 of the authentication terminal 2 creates a worker ID when the worker holding the authentication terminal 2 is authenticated as a worker having valid ownership of the authentication terminal 2 by the behavior authentication, and transmits an authentication result as the worker ID to the management terminal 3. The management terminal 3 determines whether or not the worker 81 has the authority to inspect the product B on the basis of the worker ID transmitted from the authentication terminal 2.

In this case, the management terminal 3 stores, in the worker ID storage unit 351, inspection authority association information in which the worker ID is associated with inspection authority information, which is information on the inspection authority as the authority to inspect a product, for each type of product. If determining that the worker ID transmitted from the authentication terminal 2 is not registered in the inspection authority association information for the product B, the authority management unit 34 of the management terminal 3 can determine that the worker 81 does not have the authority to inspect the product B.

The authority management unit 34 notifies the authentication terminal 2 of the worker 81 and the authentication terminal 2 of a manager 83 in charge of inspection that the worker 81 does not have the authority to perform the inspection work of the product B. For example, the authority management unit 34 transmits a message to the effect that the worker 81 who does not have the authority to perform the inspection work of the product B is performing the inspection work of the product B to the authentication terminal 2 of the worker 81 and the authentication terminal 2 of the manager 83 in charge of inspection. Note that if thereafter confirming that the worker 81 has the authority to perform the inspection work of the product B, the authority management unit 34 notifies the worker 81 and the like of permission to continue the work.

Also, if determining that the worker ID transmitted from the authentication terminal 2 held by the worker 81 is registered in the inspection authority association information for the product B, the authority management unit 34 can determine that the worker 81 has the authority to inspect the product B. That is, in the inspection authority management system 80, the authority management unit 34 can easily and immediately determine whether or not the worker 81 has the authority to inspect the product B on the basis of the worker ID transmitted from the authentication terminal 2 and the inspection authority association information.

As described above, in the inspection authority management system 80, the management terminal 3 can immediately detect whether or not the worker 81 has the authority to perform the inspection work of the product B on the basis of the result of the behavior authentication on the authentication terminal 2, and a third party such as the manager 83 in charge of inspection can easily check whether or not any worker has the authority to perform the inspection work. This can easily prevent a worker who does not have valid authority to perform work from performing the work.

### Second Embodiment

### Management of Entry/Exit of Guest

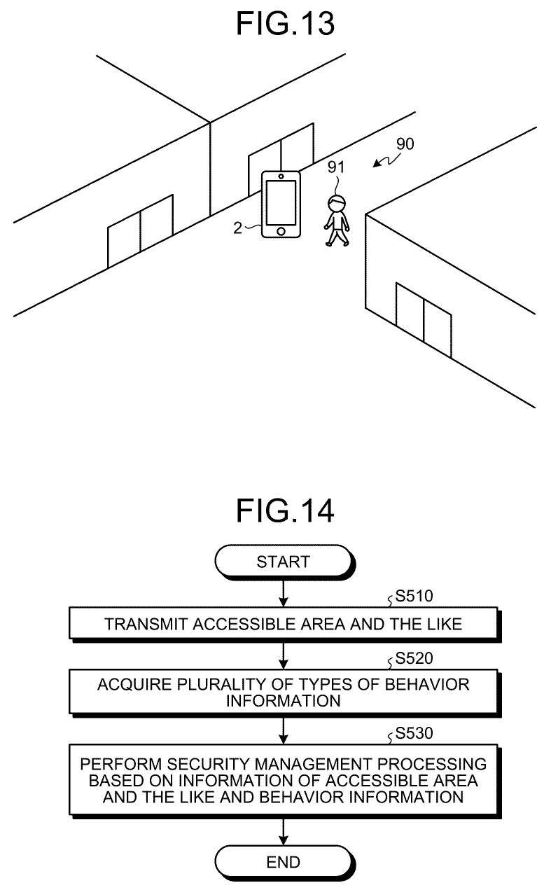

A second embodiment will describe a case where the behavior authentication of the authentication terminal 2 is applied to the management of entry/exit of a guest into/from a factory. FIG. 13 is a conceptual diagram for explaining a case where a security system according to the second embodiment is applied to a guest in a factory. FIG. 13 illustrates a situation in which a guest 91 travels through the factory while holding the authentication terminal 2. In a security system 90 according to the second embodiment, the guest 91 holds the authentication terminal 2 in the factory as illustrated in FIG. 13.

In the second embodiment, when the guest 91 enters the factory, the authentication terminal 2 for rent is given to the guest 91, or an application having the function of the authentication terminal 2 is installed on a smartphone of the guest 91. In the case where the application having the function of the authentication terminal 2 is installed on the smartphone of the guest 91, the smartphone of the guest 91 serves as the authentication terminal 2. From then on, the guest 91 moves in the factory while holding the authentication terminal 2 to be managed by an authentication terminal ID of the authentication terminal 2. The smartphone of the guest 91 to serve as the authentication terminal 2 needs to register the worker ID, that is, the authentication terminal ID of the authentication terminal 2 before use, or when the application having the function of the authentication terminal 2 is installed. Note that the “guest” in the second embodiment includes a temporary worker in the factory in addition to a guest who is not a worker in the factory.

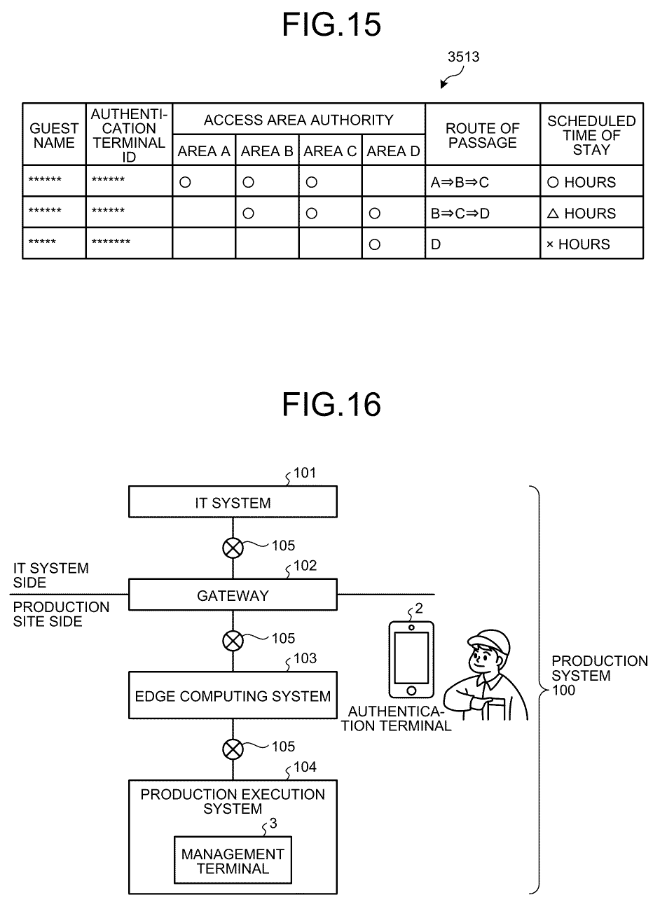

Hereinafter, an example of an operation of the security system 90 will be described. FIG. 14 is a flowchart illustrating a procedure of the operation of the security system according to the second embodiment. FIG. 15 is a table illustrating an example of a database provided in the storage unit of the management terminal in the security system according to the second embodiment. In the security system 90 according to the second embodiment, the management terminal 3 stores and manages, for the guest 91, information such as a guest name, the authentication terminal ID, access area authority, a route of passage, and a scheduled time of stay in a database 3513 illustrated in FIG. 15 provided in the storage unit 35. The access area authority is information on an area in the factory for which the access authority of the guest 91 is granted. The access area authority may be managed in detail by being divided into, for example, a room entry permitted area in which entry to a room of a building is permitted and an access permitted area in which access to an area other than the room of the building is permitted.

Before the smartphone of the guest 91 is used as the authentication terminal 2, the smartphone of the guest 91 to serve as the authentication terminal 2 installs the application having the function of the authentication terminal 2 and registers the worker ID, that is, the authentication terminal ID of the authentication terminal 2. Then, the guest 91 performs personal authentication on the authentication terminal 2 to create the authentication terminal ID, and registers the authentication terminal ID in the database 3513 of the management terminal 3. That is, the registration processing of registering the guest 91 and the authentication terminal 2 in the database 3513 of the management terminal 3 is performed on the authentication terminal 2. Moreover, when the guest 91 and the authentication terminal 2 are registered in the database 3513, the management terminal 3 performs registration processing of registering the information such as the access area authority, the route of passage, and the scheduled time of stay in the database 3513. The security system 90 thereafter performs the operation according to the flowchart illustrated in FIG. 14.

In step S510, the management terminal 3 transmits information on an accessible area and the like to the authentication unit 25 of the authentication terminal 2 held by the guest 91. Here, it is assumed that the information on the accessible area and the information on the room entry permitted area are transmitted to the authentication unit 25 of the authentication terminal 2.

In step S520, upon receiving the information on the room entry permitted area and the accessible area, the authentication unit 25 of the authentication terminal 2 held by the guest 91 acquires a plurality of types of the behavior information of the guest 91. Here, the behavior information acquired by the authentication unit 25 includes information on a history on a room entry card reader installed for each room of the building, information on a position of the guest 91 in the factory, information on a passage history of the guest 91 in the factory, information on a duration of stay of the guest 91 in the factory, and the like.

In a case where the application having the function of the authentication terminal 2 is installed on the smartphone of the guest 91, information that can be acquired as the behavior information also includes, in addition to the behavior information described above, information regarding photographing with a camera on the smartphone of the guest 91 and information regarding recording on the smartphone of the guest 91.

In step S530, if necessary, the authentication terminal 2 performs security management processing based on the information on the accessible area and the like and the behavior information. The security management processing is processing of protecting the information in the factory by permitting or prohibiting access to the information in the factory by the guest 91.

On the basis of the information on the accessible area and the behavior information of the guest 91 received, for example, the authentication terminal 2 transmits the authentication terminal ID as authentication permission to permit the access to the room entry card reader or issues an alarm indicating that the access is not permitted from the authentication terminal 2. That is, the movement of the guest 91 in the room entry permitted area and accessible area indicated by the received information is treated as authorized behavior information of the guest 91. In this case, the authentication terminal 2 authenticates the guest 91 as a person having valid ownership of the authentication terminal 2.

Furthermore, the movement of the guest 91 outside the room entry permitted area and the movement of the guest 91 outside the accessible area are treated as unauthorized behavior information of the guest 91, that is, behavior information not permitted for the guest 91. In this case, the authentication terminal 2 determines the guest 91 as a person not having valid ownership of the authentication terminal 2, and thus the behavior authentication fails.

In a case where the authentication based on the behavior information of the guest 91 has failed due to the movement of the guest 91 outside the room entry permitted area indicated by the received information and the movement of the guest 91 outside the accessible area, the authentication unit 25 of the authentication terminal 2 notifies the guest 91 of the failure by a voice message of “Entry to this area is prohibited”, for example. In addition, the authentication unit 25 notifies a monitoring terminal installed in a safety office, reception, and the like of the fact that the authentication based on the behavior information has failed and information for specifying the corresponding authentication terminal 2.

Also, in a case where the authentication unit 25 of the authentication terminal 2 detects an action of photographing with the camera and an action of recording outside the permitted area by acquiring the behavior information, the authentication based on the authorized behavior information of the guest 91 fails because such actions of the guest 91 are not the permitted and authorized behavior. In this case, the authentication unit 25 gives notification to that effect to the guest 91 by a voice message of “Photographing is prohibited in this area”, for example. In addition, the authentication unit 25 notifies the monitoring terminal installed in the safety office, reception, and the like of the fact that the authentication based on the behavior information has failed and the information for specifying the corresponding authentication terminal 2.

As described above, the security system 90 can detect the behavior of the guest 91 that is not permitted through the behavior authentication, and thus can provide security against unauthorized movement of the guest 91 in the factory. Moreover, the guest 91 who is well-intentioned merely performs the permitted behavior so that the security system 90 basically does not cause discomfort to the guest 91.

### Third Embodiment

### Authentication of Person Authorized to Use Information Technology (IT) System

A third embodiment will describe application to authentication of an access right to a production system in a factory. FIG. 16 is a conceptual diagram for explaining a production system in a factory according to the third embodiment. A production system 100 in a factory according to the third embodiment includes an IT system 101, a gateway 102, an edge computing system 103, and a production execution system 104. The IT system 101 and the gateway 102, the gateway 102 and the edge computing system 103, and the edge computing system 103 and the production execution system 104 are each connected via Internet 105.

The production execution system 104 controls the equipment 4 to execute production activities. The edge computing system 103 collects various data obtained from a sensor and the equipment 4 in the operation and control of the equipment 4, performs certain primary processing, and transmits the data to the IT system 101. The IT system 101 analyzes the data transmitted from the edge computing system 103.

The production system 100 in the factory according to the third embodiment separates a side of the IT system and a side of the production site by the gateway 102. Furthermore, on the side of the production site, a security system applying the authentication technique in the security system 1 according to the first embodiment is provided. That is, a worker holds the authentication terminal 2 described above, and the management terminal 3 is incorporated in the production execution system 104.

As a result, in the production system 100 of the factory according to the third embodiment, only a worker having valid ownership of the authentication terminal 2 and authenticated by the authentication terminal 2 can connect to the production execution system 104. That is, in the production system 100, only the worker having valid ownership of the authentication terminal 2 can connect to the production execution system 104, so that the authority to allow use of the IT system 101 via the production execution system 104 can be limited.

As a result, the production system 100 can prevent a person other than the worker having valid authority to connect to the production execution system 104 from accessing the production execution system 104, and deter ransom payment due to intrusion of ransomware into the production system 100 from the side of the production site.

### Fourth Embodiment

### Grasping Stock Location for Part, Semi-Finished Product, and the Like

A manufacturing site has a problem that one doesn’t know “who has placed how many objects at what time and what place”. The objects include parts and semi-finished products. A fourth embodiment will describe a site management system 110 that solves this problem using the authentication terminal 2 that has installed the application having the function of personal authentication based on the behavior information described in the first embodiment. The following description assumes that a worker who holds the authentication terminal 2 is a worker who has valid ownership of the authentication terminal 2. The following description further assumes that the authentication terminal 2, the management terminal 3, and the production management system 5 are included in the site management system 110.

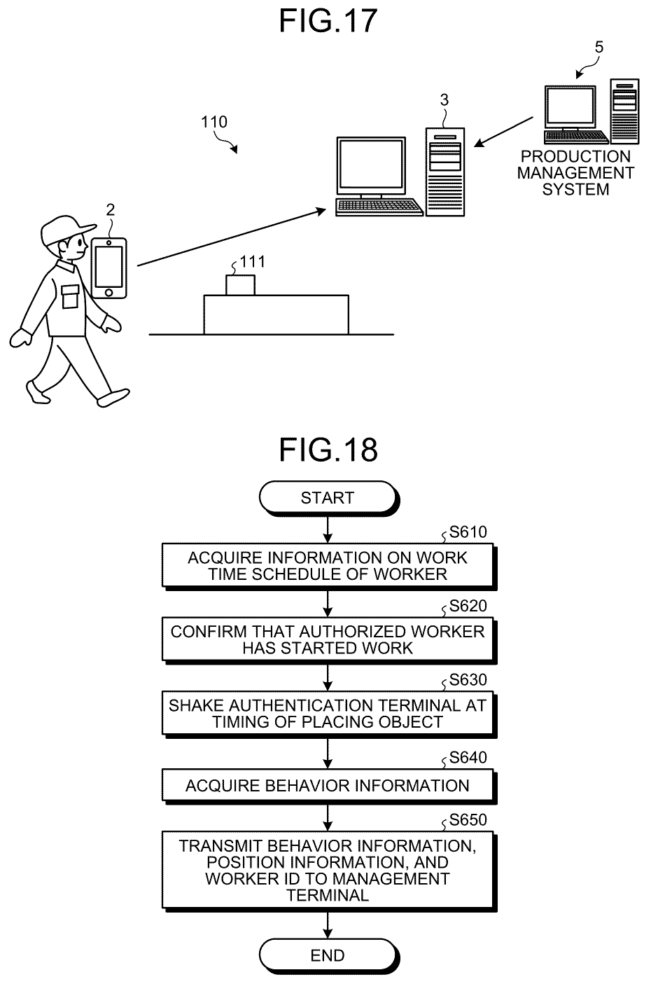

FIG. 17 is a conceptual diagram for explaining the site management system of a factory according to the fourth embodiment. FIG. 18 is a flowchart illustrating a procedure of processing in the site management system of the factory according to the fourth embodiment.

In step S610, the authority management unit 34 of the management terminal 3 acquires “information on who performs which work at what time” as information on a work time schedule of the worker from the production management system 5 that manages the work time schedule of the worker.

In step S620, the authority management unit 34 of the management terminal 3 finds out whether work has been started by an authorized worker by input of the “information on who performs which work at what time” at the time the worker has started work.

In step S630, the worker shakes the authentication terminal 2 several times at a timing of placing an object 111 such as a part or a semi-finished product somewhere in the factory after starting the work. That is, vibration is applied to the authentication terminal 2 at the timing when the worker places the object 111 somewhere in the factory.

In step S640, the behavior information acquisition unit 232 acquires the behavior information. The behavior information acquisition unit 232 recognizes the action of the worker shaking the authentication terminal 2 as the behavior information, and acquires the behavior information together with other types of the behavior information. Note that the way the worker shakes the authentication terminal 2 is not limited as long as the behavior information acquisition unit 232 can recognize the action of the worker shaking the authentication terminal 2 as the behavior information.

In step S650, the authentication unit 25 performs personal authentication based on biometric authentication and the plurality of types of the behavior information to create worker ID information. Then, the authentication unit 25 transmits the behavior information, position information of the authentication terminal 2 indicating the position of the authentication terminal 2, and the worker ID information to the management terminal 3.

In the fourth embodiment, the authority management unit 34 of the management terminal 3 identifies the number of objects by the way the authentication terminals 2 is shaken. For example, in a case where it is recognized from the behavior information that the authentication terminal 2 is shaken once, the authority management unit 34 determines that one piece of the object 111 is placed. In a case where it is recognized from the behavior information that the authentication terminal 2 is shaken twice, the authority management unit 34 determines that two pieces of the objects 111 are placed. The authority management unit 34 can confirm the number of the objects 111 placed in a way that the correctness of the information can be guaranteed by the behavior information.

Moreover, the authority management unit 34 identifies a place where the object 111 is placed on the basis of the position information of the authentication terminal 2 acquired from the authentication terminal 2. That is, the position information of the authentication terminal 2 is used as position information of a stock location where the object 111 is placed. The authority management unit 34 can confirm the place where the object 111 is placed in a way that the correctness of the information can be guaranteed by the position information of the authentication terminal 2.

Furthermore, the authority management unit 34 identifies the worker who places the object 111 from the worker ID information. The authority management unit 34 can confirm the worker who places the object 111 in a way that the correctness of the information can be guaranteed by the worker ID.

According to the above method, the authority management unit 34 can acquire the information on “who has placed how many objects at which place”. In addition, the authority management unit 34 can identify the date and time when the object 111 is placed by associating the date and time when the information such as the behavior information is acquired from the authentication terminal 2 with the information such as the behavior information.

The authority management unit 34 can confirm the date and time when the object 111 is placed in a way that the correctness of the information can be guaranteed by the time of reception of the behavior information and the like. The authority management unit 34 can also confirm details of the object 111 in a way that the correctness of the information can be guaranteed by the “information on who performs which work at what time” in the information on the work time schedule of the worker.

The information on “who has placed how many objects at which place” can also be obtained by a method of photographing with a camera and leaving a record of the situation when the worker places the object 111. However, in this case, an application of the camera needs to be started every time the worker places the object 111, which causes the operation to be inconvenient and the processing to take time.

On the other hand, according to the site management system 110 described above, the authority management unit 34 of the management terminal 3 can acquire the information such as “who has placed how many objects at which place” by a simple method that does not require processing such as photographing with a camera. Therefore, the authority management unit 34 can easily acquire the information such as “who has placed how many objects at which place” by a simple method that is not burdensome for the worker.

As described above, the authority management unit 34 of the management terminal 3 acquires the “information on who performs which work at what time” as the information on the work time schedule of the worker from the production management system 5, and acquires the behavior information, the position information of the authentication terminal 2, and the worker ID information from the authentication terminal 2, thereby being able to easily and reliably grasp the stock location for the part, semi-finished product, or the like. As a result, the site management system 110 can solve the problem that one doesn’t know “who has placed how many objects at what time and what place”. Note that a functional unit having the function of the authority management unit 34 described above may be provided as an item management unit separately from the authority management unit 34, for example.

### Fifth Embodiment

### Authentication of Jig/Tool User and Grasping Of Current Position of Jig/Tool

A manufacturing site has a problem that one doesn’t know “where each jig/tool is now” and “who took the jig/tool”. A fifth embodiment will describe a site management system 120 that solves this problem using the authentication terminal 2 that has installed the application having the function of personal authentication based on the behavior information described in the first embodiment. The following description assumes that a worker who holds the authentication terminal 2 is a worker who has valid ownership of the authentication terminal 2. The following description further assumes that the authentication terminal 2, the management terminal 3, and the production management system 5 are included in the site management system 120. In addition, the management terminal 3 functions as a site management device that grasps a current position of a jig/tool.

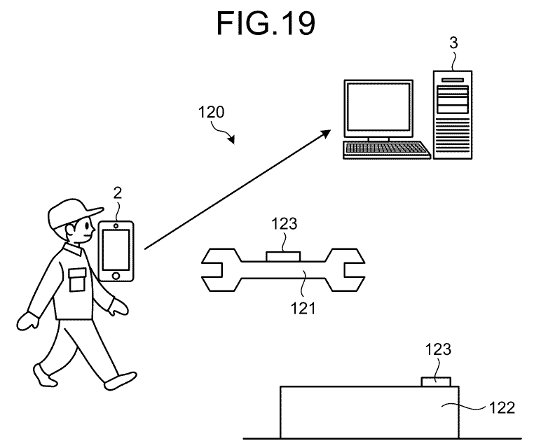

FIG. 19 is a conceptual diagram for explaining the site management system of a factory according to the fifth embodiment. In the fifth embodiment, a radio tag 123 is attached in advance to at least either one of a jig/tool 121 and an installation base 122 as a place where the jig/tool 121 is to be placed. Here, it is assumed that the radio tag 123 needs to be attached to at least the installation base 122. It is assumed that there are a plurality of the installation bases 122.

At a timing when wireless communication occurs between the authentication terminal 2 held by the worker and the radio tag 123 attached to at least either one of the jig/tool 121 and the installation base 122, the authentication terminal 2 performs personal authentication and transmits, to the management terminal 3, information on which of the jig/tool 121 and the installation base 122 the wireless communication has occurred with, a worker ID, a tag number unique to each radio tag 123, and position information of the authentication terminal 2 indicating the position of the authentication terminal 2. As a result, a user of the jig/tool 121 is authenticated.

Also, at a timing when non-wireless communication occurs between the radio tag 123 attached to the jig/tool 121 and the authentication terminal 2, the authentication terminal 2 performs personal authentication and transmits, to the management terminal 3, information indicating the occurrence of the non-wireless communication with the jig/tool 121, the worker ID, and the position information of the authentication terminal 2.

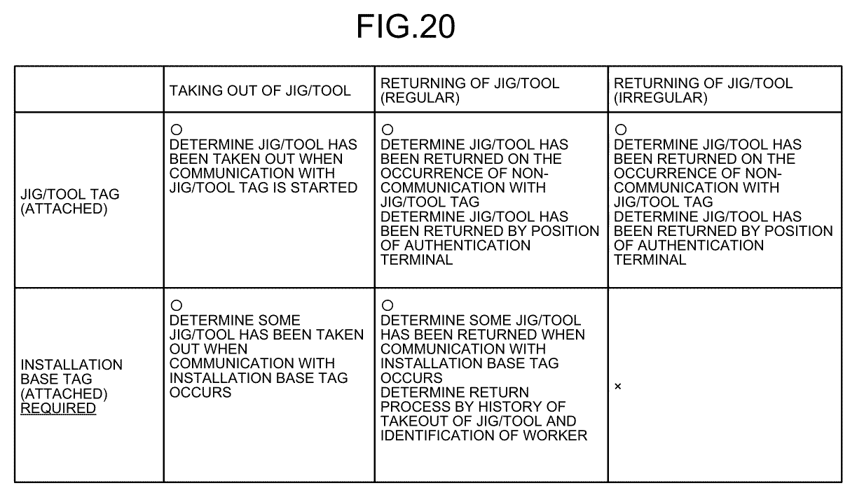

The authority management unit 34 of the management terminal 3 manages the location of the jig/tool 121 on the basis of the following idea using the worker ID, the tag number, and the position information of the authentication terminal 2 that are transmitted from the authentication terminal 2 as well as information on the date and time when the above information such as the worker ID is received from the authentication terminal 2. FIG. 20 is a table illustrating a determination method on the management terminal 3 according to the fifth embodiment.

The management at the time of “taking out of the jig/tool” is as follows. Hereinafter, the radio tag 123 attached to the jig/tool 121 may be referred to as a jig/tool tag 123. Also, the radio tag 123 attached to the installation base 122 may be referred to as an installation base tag 123.

In a case where the jig/tool tag 123 is attached to the jig/tool 121, with the occurrence of wireless communication between the authentication terminal 2 and the jig/tool tag 123, that is, with the start of communication between the authentication terminal 2 and the jig/tool tag 123, the authority management unit 34 of the management terminal 3 determines “taking out of the jig/tool” indicating that the jig/tool 121 has been taken out. In a case where the jig/tool tag 123 is not attached to the jig/tool 121, with the occurrence of wireless communication between the authentication terminal 2 and the installation base tag 123, the authority management unit 34 of the management terminal 3 determines that “some jig/tool 121 has been taken out”.

The management at the time of “returning of the jig/tool (regular)” is as follows. The returning of the jig/tool (regular) corresponds to a case where the jig/tool 121 has been returned to the installation base 122 that is placed somewhere. In a case where the jig/tool tag 123 is attached to the jig/tool 121, with the occurrence of non-communication between the authentication terminal 2 and the jig/tool tag 123, the authority management unit 34 of the management terminal 3 determines that the worker has returned the jig/tool 121. The occurrence of non-communication between the authentication terminal 2 and the jig/tool tag 123 corresponds to a case where the wireless communication that has been established between the authentication terminal 2 and the jig/tool tag 123 is interrupted.

The authority management unit 34 of the management terminal 3 uses the position information of the authentication terminal 2 to determine that returning of the jig/tool 121 to the installation base 122 has been performed when the position information of the authentication terminal 2 matches the position information of any of the installation bases 122. That is, the authority management unit 34 of the management terminal 3 determines the returning of the jig/tool 121 to the installation base 122 on the basis of the position of the authentication terminal 2. The match between the position information of the authentication terminal 2 and the position information of the installation base 122 need not be a perfect match in consideration of the accuracy of the position information, the size of the installation base 122, and the like.

In a case where the jig/tool tag 123 is not attached to the jig/tool 121, with the occurrence of communication between the authentication terminal 2 and the installation base tag 123, the authority management unit 34 of the management terminal 3 determines that some jig/tool 121 has been returned to the installation base 122. The authority management unit 34 of the management terminal 3 determines the returning of a specific jig/tool 121, that is, a return process of the jig/tool 121 on the basis of a history of takeout of the jig/tool 121 and identification of the worker who has returned the jig/tool 121 to the installation base 122.

The management at the time of “returning of the jig/tool (irregular)” is as follows. The returning of the jig/tool (irregular) corresponds to a case where the jig/tool 121 is returned but not to the installation base 122, that is, a case where the jig/tool 121 is left at a place other than the installation base 122. In a case where the jig/tool tag 123 is attached to the jig/tool 121, with the occurrence of non-communication between the authentication terminal 2 and the jig/tool tag 123, the authority management unit 34 of the management terminal 3 determines that the worker has returned the jig/tool 121.

However, in this case, the jig/tool 121 has not been returned to the installation base 122. In this case, the authority management unit 34 of the management terminal 3 determines the place to which the jig/tool 121 has been returned using the position information of the authentication terminal 2. In a case where the jig/tool 121 has been lost, a user who has used the lost tool last can be identified from the worker ID information at the time of wireless communication with the installation base tag 123. The jig/tool 121 that has been lost can be identified by, for example, a process of elimination using a list of the jigs/tools 121.

As described above, in the site management system 120, the radio tag 123 is attached to at least either one of the jig/tool 121 and the installation base 122. Then, the authority management unit 34 of the management terminal 3 can determine the current position of the jig/tool 121 by acquiring and monitoring the information transmitted from the authentication terminal 2 such as the worker ID, the tag number, the position information of the authentication terminal 2, the information on which of the jig/tool 121 and the installation base 122 the wireless communication has occurred with, and the information indicating the occurrence of the non-wireless communication with the jig/tool 121. As a result, the site management system 120 can solve the problem that one doesn’t know “where each jig/tool is now” and “who took the jig/tool”. Note that a functional unit having the function of the authority management unit 34 described above may be provided as a jig/tool management unit separately from the authority management unit 34, for example.

### Sixth Embodiment

### First Case of Reinforcement Learning

In the behavior authentication of the first embodiment described above, the user who holds the authentication terminal 2 is authenticated as the worker having valid ownership of the authentication terminal 2 by personal authentication. Since the behavior information itself is somewhat broad information, it is necessary to multiply the similarities for the plurality of types of the behavior information used for personal authentication by the coefficients in accordance with the accuracy of the behavior information as described above. Appropriate values for the coefficients are automatically calculated by utilizing machine learning. Here, the coefficients mean “a”, “b”, and the like that are coefficients in the following expression (1). Moreover, as for the behavior information whose accuracy is relatively low and whose reliability is low, the importance of the behavior information is set low, and the coefficient is set low. As for the behavior information whose accuracy is relatively high and whose reliability is high, the importance of the behavior information is set high, and the coefficient is set high. Whether or not the worker can be authenticated based on the behavior authentication on the authentication terminal 2 is determined on the basis of an overall similarity.

$$\begin{matrix}\text{Overall similarity =} α \times \left(\text{similarity of behavior information A}\right) \\ + \text{b} \times \left(\text{similarity of behavior information B}\right) + …\end{matrix}$$

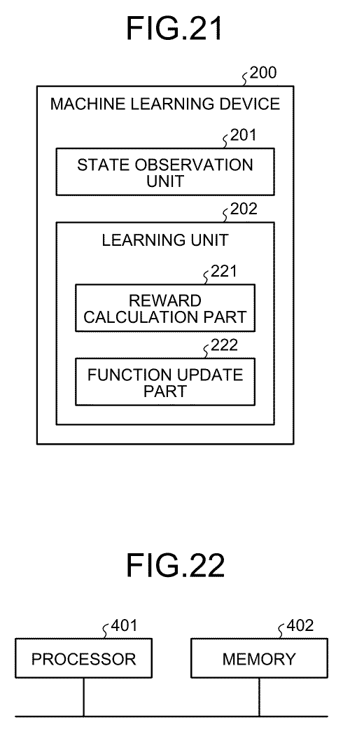

FIG. 21 is a diagram illustrating a configuration of a machine learning device according to a sixth embodiment. In the sixth embodiment, the authentication unit 25 of the authentication terminal 2 includes a state observation unit 201 and a learning unit 202 as a machine learning device 200. Parameters used in a specific machine learning method, which will be described later, will be described below. The authentication unit 25 of the authentication terminal 2 performs machine learning using the following parameters.

“Target item”
Authentication terminal
“First input (action)”
Coefficient for each behavior information

The coefficient for each behavior information is a coefficient set for each type of the behavior information. “Second input (state)”
User authentication accuracy
The user authentication accuracy is the accuracy of authentication as to whether an authorized user has been properly authenticated.
Relationship between similarity and coefficient
The relationship between the similarity and the coefficient indicates whether or not the coefficient is large with respect to the similarity. “Output (learning content)”
Coefficient by which behavior information is multiplied
The coefficient by which the behavior information is multiplied is set for each type of the behavior information. “Reward criterion”
User authentication accuracy
The user authentication accuracy is the accuracy of proper authentication of an authorized user, that is, the accuracy of output of a worker ID. “Reward increase criterion” The reward increase criterion is a criterion for increasing a reward in a case where an authorized user is properly authenticated. “Reward decrease criterion” The reward decrease criterion is a criterion for decreasing a reward in a case where an authorized user is not properly authenticated.

(Second case of reinforcement learning) In the behavior authentication of the first embodiment described above, the commuting route and travel route and the time corresponding thereto of the behavior information are data with fluctuations having a position error, a route error, and a time error including the accuracy of the sensor that performs the measurement. Moreover, in a case where the user holding the authentication terminal 2 goes to a new destination, the behavior information needs to be newly created. Therefore, route and time information suitable for personal authentication on the authentication terminal 2 is created by utilizing machine learning.

In the sixth embodiment, the behavior information acquisition unit 232 includes the state observation unit 201 and the learning unit 202 as the machine learning device 200. Parameters used in a specific machine learning method, which will be described later, will be described below. The behavior information acquisition unit 232 performs machine learning using the following parameters.

“Target item”
Authentication terminal
“First input (known information)”
Behavior information for each route
The behavior information for each route includes position and time. “Second input (target of estimation)”
Start point, destination point, and required point of passage of route
“Output (learning content)”
Behavior information for the route of second input “Reward criterion”
User authentication accuracy
The user authentication accuracy is the accuracy of proper authentication of an authorized user, that is, the accuracy of output of a worker ID. “Reward increase criterion” The reward increase criterion is a criterion for increasing a reward in a case where an authorized user is properly authenticated. “Reward decrease criterion” The reward decrease criterion is a criterion for decreasing a reward in a case where an authorized user is not properly authenticated.

The specific machine learning methods in the first case and the second case will be described below.

The state observation unit 201 observes the information on the first input and the second input described above as state variables. Specifically, in the first case, the coefficient for each behavior information, the user authentication accuracy, and the relationship between the similarity and the coefficient are observed as the state variables. In the second case, the start point, destination point, and required point of passage of the route, and the behavior information for each route are observed as the state variables.

The learning unit 202 learns the output (learning content) according to a data set created on the basis of the state variables of the first input and the second input. Specifically, in the first case, the coefficient by which the behavior information is multiplied is learned. In the second case, the behavior information for the route of the second input is learned.

The learning unit 202 may use any learning algorithm. As an example, a case where reinforcement learning is applied will be described.

Reinforcement learning is a learning method in which an agent (subject of action) in a certain environment observes a current state and determines an action to take. The agent receives a reward from the environment by choosing an action and learns a policy that maximizes the reward through a series of actions. As representative methods of reinforcement learning, Q learning and TD learning are known. In the case of Q learning, for example, a general update expression (an action-value table) of an action-value function Q (s, a) is expressed by expression (2).

$$\text{Q} \left({s}_{t} , {a}_{t}\right) ← \text{Q} \left({s}_{t} , {a}_{t}\right) + α \left({r}_{t + 1} + γ {{max}_{a} Q \left({s}_{t + 1} , a\right) - \text{Q} \left({s}_{t} , {a}_{t}\right)}_{}\right)$$

In the update expression represented by expression (2) in Q learning, “t” represents a state at time “t”, and “at” represents an action at time “t”. The state transitions to “st+1” by the action “at”. Moreover, “rt+1” represents a reward given by the change in the state, “γ” represents a discount factor, and “α” represents a learning rate. Note that “γ” is in a range of O<γ≤1, and “α” is in a range of 0<α≤1. In the case where Q learning is applied, C output (learning content) is the action “at”.

The update expression represented by expression (2) increases an action value “Q” if the best action value of the action “a” at time “t+1” is higher than the action value “Q” of the action “a” performed at time “t”, or decreases the action value “Q” in an opposite case. In other words, the action-value function Q (s, a) is updated such that the action value “Q” of the action “a” at time “t” approaches the best action value at time “t+1”. As a result, the best action value in a certain environment sequentially propagates to action values in previous environments.

The learning unit 202 includes a reward calculation part 221 that calculates a reward for learning, and a function update part 222 that updates the function for learning and determines the action value Q that is an evaluation value.

The reward calculation part 221 calculates the reward on the basis of the state variables. The reward calculation part 221 calculates a reward “r” on the basis of the reward criterion. For example, in a case of the reward increase criterion, the reward calculation part 221 increases the reward “r” and gives a reward of “1”, for example. On the other hand, in a case of the reward decrease criterion, the reward calculation part 221 decreases the reward “r” and gives a reward of “-1”, for example. The reward criterion is extracted according to a known method.

The function update part 222 updates a function for determining the learning content to be learned by the learning unit 202 according to the reward calculated by the reward calculation part 221. In the case of Q learning, for example, the action-value function Q (st, at) represented by expression 2 is used as the function for calculating the learning content.

Note that the present embodiment has described the case where the reinforcement learning is applied as the learning algorithm used by the learning unit 202, but the learning algorithm is not limited thereto. Besides reinforcement learning, it is also possible to apply supervised learning, unsupervised learning, semi-supervised learning, or the like as the learning algorithm.

Moreover, as the learning algorithm described above, deep learning that learns extraction of a feature value itself can be used, or another known method such as neural network, genetic programming, functional logic programming, or support vector machine may be used to perform machine learning.

Note that the machine learning device is used to learn the learning content for the target item but may be, for example, a device connected to the target item via a network and separate from the target item. Alternatively, the machine learning device may be built in the target item. Yet alternatively, the machine learning device 200 may be on a cloud server.

Moreover, the learning unit 202 may learn the learning content according to data sets created for a plurality of the target items. Note that the learning unit 202 may learn the learning content by acquiring data sets from a plurality of the target items used in the same site, or using data sets collected from a plurality of machine tools operating independently in different sites. Moreover, the target item from which the data set is collected can be added to the target or removed from the target along the way. Furthermore, the machine learning device that has learned the learning content for a certain target item may be attached to another target item, and relearn and update the learning content for the other target item.

The control unit of each of the acquisition unit 23 of the authentication terminal 2, the authentication unit 25 of the authentication terminal 2, the ID creation/storage unit 26 of the authentication terminal 2, the registration unit 33 of the management terminal 3, the authority management unit 34 of the management terminal 3, and the use permission unit 41 of the equipment 4 is implemented as processing circuitry having a hardware configuration illustrated in FIG. 22. FIG. 22 is a diagram illustrating an example of the hardware configuration of the processing circuitry in the first embodiment. When implemented by the processing circuitry illustrated in FIG. 22, each control unit described above is implemented by a processor 401 executing a program stored in a memory 402. Alternatively, a plurality of processors and a plurality of memories may cooperatively implement the functions of each control unit described above. Yet alternatively, some of the functions of each control unit described above may be implemented as an electronic circuit, and the other functions may be implemented by using the processor 401 and the memory 402.

The configurations illustrated in the above embodiments merely illustrate an example so that another known technique can be combined, the embodiments can be combined together, or the configurations can be partially omitted and/or modified without departing from the scope of the present disclosure.

### REFERENCE SIGNS LIST

1, 60, 60a, 70, 90 security system; 2 authentication terminal; 3 management terminal; 4 equipment; 5 production management system; 21, 31 input unit; 22, 32 display unit; 23 acquisition unit; 24, 35, 42 storage unit; 25 authentication unit; 26 ID creation/storage unit; 27, 36, 43 communication unit; 33 registration unit; 34 authority management unit; 41 use permission unit; 61 cloud server; 62 Internet; 63 IoT factory controller; 71 gate; 72 wall; 73 reader terminal; 74 communication device; 80 inspection authority management system; 81 worker; 82 entry confirmation device; 83 manager; 91 guest; 110 site management system; 111 object; 231 biometric information acquisition unit; 232 behavior information acquisition unit; 241 biometric information storage unit; 242 behavior information storage unit; 351 worker ID storage unit; 611 software PLC; 2321 first behavior information acquisition unit; 2322 second behavior information acquisition unit; 2323 third behavior information acquisition unit; 3511, 3513 database; 3512 use authority information record.

1. An authentication terminal held by a worker to perform personal authentication, the authentication terminal comprising:
behavior information acquisition circuitry to acquire a plurality of types of behavior information acquired on the basis of an action of the worker who is a subject of personal authentication, the plurality of types of the behavior information being information that indicates behavior specific to the worker and information that identifies the worker; and
authentication circuitry to perform identity personal authentication of the worker on the basis of a comprehensive evaluation obtained by comprehensively evaluating the plurality of types of the behavior information.

2. The authentication terminal according to claim 1, comprising
biometric information acquisition circuitry to acquire biometric information of the worker, wherein
the authentication circuitry performs the personal authentication of the worker on the basis of the comprehensive evaluation of the plurality of types of the behavior information after identifying, on the basis of the biometric information, that the worker is a person registered in the authentication terminal as an authorized holder of the authentication terminal.

3. The authentication terminal according to claim 1, comprising
authentication result output circuitry to output, after the authentication circuitry performs the personal authentication of the worker, an authentication result that proves the identity of the worker and identification information that is associated with the worker and unique to the worker.

4. A security system comprising:
an authentication terminal including:
behavior information acquisition circuitry to acquire a plurality of types of behavior information acquired on the basis of an action of a worker who is a subject of personal authentication;
authentication circuitry to perform personal authentication of the worker on the basis of a comprehensive evaluation obtained by comprehensively evaluating the plurality of types of the behavior information; and
authentication result output circuitry to output, after the authentication circuitry performs the personal authentication of the worker, an authentication result that proves the identity of the worker and identification information that is associated with the worker and unique to the worker; and
a management terminal to manage the identification information of the worker and enable a function of equipment to be used by the worker after receiving the authentication result of the personal authentication and the identification information from the authentication terminal.

5. The security system according to claim 4, comprising
biometric information acquisition circuitry to acquire biometric information of the worker, wherein
the authentication circuitry performs the personal authentication of the worker on the basis of the comprehensive evaluation of the plurality of types of the behavior information after identifying, on the basis of the biometric information, that the worker is a person registered in the authentication terminal as an authorized holder of the authentication terminal.

6. The security system according to claim 4, wherein
the management terminal manages association information in which the identification information of the worker is associated with the worker; and, after receiving the authentication result of the personal authentication and the identification information from the authentication terminal, enables a function of equipment to be used by the worker in a case where the identification information is managed in the association information.

7. The security system according to claim 4, wherein
the management terminal manages association information in which the identification information of the worker is associated with equipment specifying information that is information on equipment authorized to be used by the worker; and, after receiving the authentication result of the personal authentication, the identification information, and the equipment specifying information from the authentication terminal, enables a function of the equipment specified by the equipment specifying information in a case where the identification information and the equipment specifying information are managed in the association information.

8. The security system according to claim 4, wherein
the behavior information of the worker is a travel route of the worker in a factory site.

9. The security system according to claim 4, wherein
the management terminal has time schedule information according to which the worker operates the equipment, and gives the worker authority to use the equipment on the basis of the time schedule information.
